(19) United States
(12) Patent Application Publication
(10) Pub. No.: US 2026/0307605 A1
(43) Pub. Date: Oct. 8, 2026

(54) PATH RESTRICTION MEMBER AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masahiro HAGI, Mie (JP); Weichi WANG, Mie (JP)

(21) Appl. No.: 19/482,784

(22) PCT Filed: May 15, 2024
(86) PCT No.: PCT/JP2024/017989

§ 371 Date: Nov. 10, 2025

(30) Foreign Application Priority Data
May 15, 2023 (JP) 2023-080151

(51) Int. Cl. B60R 16/02; H02G 3/04; H02G 3/34

(52) U.S. Cl. CPC B60R 16/0215; H02G 3/0406; H02G 3/0487; H02G 3/34

(57) ABSTRACT

A path restriction member includes a straight component and a bent component. The straight component has a holding portion configured to hold an electric wire member, and a coupling portion. The bent component has a holding portion configured to hold the electric wire member, and a coupling portion coupled to the coupling portion. The coupling portion has an accommodation portion provided in the holding portion and a latch portion accommodated in the accommodation portion. The latch portion includes a latch body having a protruding portion that protrudes outside the accommodation portion, and a biasing member that biases the latch body toward the coupling portion. The coupling portion has a fitting recess that fits into the protruding portion. The latch body is displaceable against the biasing force of the biasing member to an orientation in which the protruding portion is accommodated inside the accommodation portion.

### DESCRIPTION

### Technical Field

The present disclosure relates to a path restriction member and a wire harness.

### Background

Conventionally, a wire harness routed inside a vehicle such as a hybrid automobile or an electric automobile is known which includes an electric wire member and a path restriction member that restricts the path of the electric wire member (e.g., see Patent Document 1).

### PRIOR ART DOCUMENT

### Patent Document

Patent Document 1: JP 2019-053894 A

### SUMMARY OF THE INVENTION

### Problems to be Solved

Incidentally, in the above-mentioned wire harness, a plurality of restriction components are coupled to each other to form one path restriction member in some cases. In this case, it is desirable to improve the assembly workability when coupling the plurality of restriction components to each other.

An object of the present disclosure is to provide a path restriction member and a wire harness that can improve assembly workability.

### Means to Solve the Problem

The path restriction member of the present disclosure is a path restriction member for restricting a path of an electric wire member, including: a first restriction component; and a second restriction component coupled to the first restriction component, in which the first restriction component has a first holding portion configured to hold the electric wire member, and a first coupling portion, the second restriction component has a second holding portion configured to hold the electric wire member, and a second coupling portion that is coupled to the first coupling portion, the first coupling portion has an accommodation portion provided in the first holding portion and a latch portion accommodated in the accommodation portion, the latch portion includes a latch body having a protruding portion protruding outside the accommodation portion, and a biasing member that biases the latch body toward the second coupling portion, the second coupling portion has a fitting recess configured to fit together with the protruding portion, and the latch body is displaceable against the biasing force of the biasing member to an orientation in which the protruding portion is accommodated inside the accommodation portion.

### Effect of the Invention

The path restriction member and the wire harness according to the present disclosure exhibit an effect of being able to improve the assembly workability.

### BRIEF DESCRIPTION OF THE DRAWINGS

FIG. 1 is a schematic configuration diagram showing a wire harness according to an embodiment.

FIG. 2 is a plan view showing the wire harness according to the embodiment.

FIG. 3 is an enlarged plan view of a portion of the wire harness according to the embodiment.

FIG. 4 is a perspective view showing the wire harness according to the embodiment.

FIG. 5 is an exploded perspective view showing a path restriction member according to the embodiment.

FIG. 6 is an exploded perspective view showing a straight component according to the embodiment.

FIG. 7 is a side view showing the straight component according to the embodiment.

FIG. 8 is an exploded perspective view showing a latch portion of the embodiment.

FIG. 9 is an enlarged cross-sectional view (cross-sectional view taken along line 9-9 in FIG. 3) showing a portion of the path restriction member according to the embodiment.

FIG. 10 is an enlarged cross-sectional view of a portion of the path restriction member according to the embodiment.

FIG. 11 is a side view showing the path restriction member according to the embodiment.

FIG. 12 is a perspective view showing a bent component according to the embodiment.

FIG. 13 is a cross-sectional view (cross-sectional view taken along line 13-13 in FIG. 11) showing a portion of the path restriction member according to the embodiment.

FIG. 14 is a perspective view showing the wire harness according to the embodiment.

FIG. 15 is a perspective view showing a method for manufacturing the path restriction member according to the embodiment.

FIG. 16 is a perspective view showing a method for manufacturing the path restriction member according to the embodiment.

FIG. 17 is a perspective view showing a method for manufacturing the path restriction member according to the embodiment.

FIG. 18 is a side view illustrating a method for manufacturing the path restriction member according to the embodiment.

FIG. 19 is a side view illustrating a method for manufacturing the path restriction member according to the embodiment.

FIG. 20 is a cross-sectional view showing a method for manufacturing the path restriction member according to the embodiment.

FIG. 21 is a cross-sectional view (a cross-sectional view taken along line 21-21 in FIG. 20) showing a method for manufacturing the path restriction member according to the embodiment.

FIG. 22 is a side view showing a method for manufacturing the path restriction member according to the embodiment.

FIG. 23 is an exploded perspective view showing a path restriction member according to a modified example.

FIG. 24 is a plan view showing a path restriction member according to a modified example.

FIG. 25 is a perspective view showing a wire harness according to a modified example.

### DETAILED DESCRIPTION TO EXECUTE THE INVENTION

### Description of Embodiments of Present Disclosure

First, embodiments of the present disclosure will be listed and described.

[1] A path restriction member of the present disclosure is a path restriction member for restricting a path of an electric wire member, including: a first restriction component; and a second restriction component coupled to the first restriction component, in which the first restriction component has a first holding portion configured to hold the electric wire member, and a first coupling portion, the second restriction component has a second holding portion configured to hold the electric wire member, and a second coupling portion that is coupled to the first coupling portion, the first coupling portion has an accommodation portion provided in the first holding portion and a latch portion accommodated in the accommodation portion, the latch portion includes a latch body having a protruding portion protruding outside the accommodation portion, and a biasing member that biases the latch body toward the second coupling portion, the second coupling portion has a fitting recess configured to fit together with the protruding portion, and the latch body is displaceable against the biasing force of the biasing member to an orientation in which the protruding portion is accommodated inside the accommodation portion.

According to this configuration, the latch body can be displaced between the first orientation in which the protruding portion protrudes outside the accommodation portion due to the biasing force of the biasing member, and the second orientation in which the protruding portion is accommodated inside the accommodation portion against the biasing force of the biasing member. In such a latch body, when the protruding portion is pressed toward the inside of the accommodation portion by the peripheral wall of the second restriction component or the like, the protruding portion is accommodated within the accommodation portion and displaced to the second orientation. In this second orientation, the protruding portion does not protrude outside the accommodation portion, and therefore the protruding portion can be prevented from interfering with the relative movement of the second restriction component with respect to the first restriction component. In addition, when the protruding portion faces the fitting recess of the second coupling portion, the pressure on the protruding portion is released, and the biasing force of the biasing member causes the protruding portion to protrude outside the accommodation portion. This allows the protruding portion to be easily fitted into the fitting recess, and allows the first coupling portion and the second coupling portion to be easily coupled to each other. Accordingly, it is possible to improve the workability when coupling the first restriction component and the second restriction component to each other.

[2] In [1] above, the latch body may have a base portion including a first surface and a second surface provided on a side opposite to the first surface, an engagement projection protruding from the first surface toward the fitting recess, and a columnar projection protruding from the second surface, the engagement projection may include a projection base portion provided on the first surface and the protruding portion provided at a distal end of the projection base portion, and the biasing member may be a coil spring attached to an outer periphery of the columnar projection.

According to this configuration, the latch body can be biased toward the fitting recess of the second coupling portion by the coil spring attached to the outer periphery of the columnar projection provided on the second surface of the base portion. In addition, when the protruding portion is pressed toward the inside of the accommodation portion by the peripheral wall or the like of the second restriction component, the coil spring is compressed, thereby displacing the latch body into the second orientation.

[3] In [2] above, the engagement projection may include two of the protruding portions that are provided at the distal end of the projection base portion and are spaced apart from each other in a peripheral direction of the path restriction member, the second coupling portion may include two of the fitting recesses into which the two protruding portions are to be respectively fitted, and each of the two protruding portions may have an engagement surface configured to engage with an inner surface of the fitting recess in the peripheral direction of the path restriction member.

According to this configuration, the two protruding portions on the latch portion of the first coupling portion are respectively fitted into the two fitting recesses on the second coupling portion. As a result, the first coupling portion and the second coupling portion are coupled to each other. Furthermore, when the first coupling portion and the second coupling portion are coupled to each other, the engagement surfaces of the two protruding portions and the inner surfaces of the two fitting recesses are engaged with each other in the peripheral direction of the path restriction member. As a result, it is possible to suppress relative movement of the second restriction component with respect to the first restriction component in the peripheral direction of the path restriction member.

[4] In [3] above, each of the two protruding portions may have a distal end surface facing the fitting recess, the two engagement surfaces may oppose each other in the peripheral direction of the path restriction member, and the distal end surface may be inclined such that a protrusion amount of the protruding portion from the projection base portion decreases as the distance from the other protruding portion increases in the peripheral direction of the path restriction member.

According to this configuration, the protruding portion can be pressed toward the accommodation portion by bringing the peripheral wall or the like of the second restriction component into contact with the distal end surface, which is the inclined surface of the protruding portion. Furthermore, by moving the peripheral wall of the second restriction component along the inclination of the distal end surface, the protruding portion can be gradually accommodated inside the accommodation portion.

[5] In any of [1] to [4] above, the accommodation portion may have a first recess recessed from an outer peripheral surface of the first holding portion toward an inner side in a radial direction of the first holding portion, a second recess that is recessed from an end surface in an axial direction of the first holding portion and is in communication with the first recess, a first peripheral wall that constitutes the inner surface of the first recess and in which the second recess is formed, a second peripheral wall that constitutes the inner surface of the first recess and opposes the first peripheral wall, and a third recess provided in the inner surface of the second peripheral wall, and an end portion of the biasing member may be accommodated in the third recess.

According to this configuration, the end portion of the biasing member is accommodated in the third recess provided on the inner surface of the second peripheral wall of the accommodation portion. As a result, it is possible to suppress the biasing member from coming out of the accommodation portion, compared to when the end portion of the biasing member comes into contact with the inner surface of the second peripheral wall.

[6] In [5] above, the first recess may be formed so as not to penetrate through the first holding portion in the radial direction.

According to this configuration, the first recess that is recessed from the outer peripheral surface of the first holding portion toward the inner side in the radial direction of the first holding portion is formed so as not to penetrate through the first holding portion in the radial direction. For this reason, an end wall is provided to close the opening on the inner side in the radial direction of the first recess. This end wall can prevent the latch portion from coming out of the first recess.

[7] In any of [1] to [6] above, the first holding portion may have a first bottom wall, a first side wall protruding from a first side edge of the first bottom wall, and a second side wall protruding from a second side edge of the first bottom wall, the first restriction component may have a first end portion in an axial direction of the first restriction component and a second end portion provided on a side opposite to the first end portion, the first restriction component may have the first coupling portion provided on the first side wall at the first end portion and a first engagement portion provided on the first side wall at the first end portion, the second holding portion may have a second bottom wall, a third side wall protruding from a third side edge of the second bottom wall, and a fourth side wall protruding from a fourth side edge of the second bottom wall, the second restriction component may have a third end portion in the axial direction of the second restriction component and a fourth end portion provided on a side opposite to the third end portion, the second restriction component may have the second coupling portion provided on the third side wall at the third end portion and a second engagement portion provided on the third side wall at the third end portion, and the first engagement portion may be engaged with the second engagement portion in the axial direction of the path restriction member.

According to this configuration, the first engagement portion of the first restriction component and the second engagement portion of the second restriction component are engaged with each other in the axial direction of the path restriction member. As a result, it is possible to suppress relative movement of the second restriction component with respect to the first restriction component in the axial direction of the path restriction member.

[8] In [7] above, the second engagement portion may have an engagement wall that extends from an outer peripheral surface at a distal end of the third side wall toward the second bottom wall and protrudes outward of the second holding portion from the outer peripheral surface of the third side wall toward the axial direction of the second holding portion, the engagement wall may be engaged with an outer peripheral surface of the first side wall in a radial direction of the first holding portion, and the engagement wall may cover a portion of the latch portion from an outer side in the radial direction of the first holding portion.

According to this configuration, a portion of the latch portion is covered from the outer side in the radial direction of the first holding portion by the engagement wall of the second engagement portion. This engagement wall can prevent the latch portion from coming out of the accommodation portion.

[9] In [8] above, the first engagement portion has a grip portion configured to grip the engagement wall, and the grip portion is engaged with the engagement wall in the axial direction of the path restriction member and is engaged with the engagement wall in the radial direction of the first holding portion.

According to this configuration, the grip portion of the first engagement portion and the engagement wall of the second engagement portion are engaged with each other in the radial direction of the first holding portion. This makes it possible to suppress relative movement of the second restriction component with respect to the first restriction component in the radial direction of the first holding portion.

[10] In any of [7] to [9] above, the first restriction component may have a third coupling portion provided on the second side wall at the first end portion, a fourth coupling portion provided on the second side wall at the second end portion, and a fifth coupling portion provided on the first side wall at the second end portion, the second restriction component may have a sixth coupling portion provided on the fourth side wall at the third end portion, the third coupling portion may have the same structure as the second coupling portion, the fourth coupling portion may have the same structure as the first coupling portion, the fifth coupling portion may have the same structure as the second coupling portion, and the sixth coupling portion may have the same structure as the first coupling portion.

According to this configuration, at the first end portion of the first restriction component, the first coupling portion is provided on the first side wall, and the third coupling portion having the same structure as the second coupling portion is provided on the second side wall. On the other hand, at the second end portion of the first restriction component, the fourth coupling portion having the same structure as the first coupling portion is provided on the second side wall, and the fifth coupling portion having the same structure as the second coupling portion is provided on the first side wall. In this way, the fourth coupling portion and the fifth coupling portion at the second end portion of the first restriction component are formed in a structure that is a 180-degree rotation of the structure of the first coupling portion and the third coupling portion at the first end portion of the first restriction component. For this reason, the second restriction component can be coupled to the first end portion of the first restriction component, and can be coupled to the second end portion of the first restriction component as well. This makes it possible to appropriately change the direction in which the second restriction component is coupled to the first restriction component in accordance with the path of the electric wire member.

[11] In any of [1] to [10] above, the first restriction component may be a straight component formed such that the first holding portion extends linearly in one direction, and the second restriction component may be a bent component in which the second holding portion has a bent portion.

According to this configuration, the first coupling portion of the straight component and the second coupling portion of the bent component can be coupled to each other.

[12] In any of [1] to [10] above, the first restriction component is a first bent component in which the first holding portion has a bent portion, and the second restriction component is a second bent component having the same structure as the first bent component.

According to this configuration, two bent components having the same structure as each other, that is, the first bent component and the second bent component, are directly coupled to each other. This makes it possible to change the bending angle of the path restriction member compared to when there is one bent component. In this way, by adjusting the number of coupled bent components of the same configuration, the bending angle of the path restriction member can be easily changed.

[13] A wire harness according to the present disclosure includes the path restriction member according to any one of [1] to [12] above, and the electric wire member whose path is restricted by the path restriction member.

According to this configuration, it is possible to obtain the same effect as the path restriction member according to [1] above.

### Details of Embodiments of the Present Disclosure

Specific examples of the path restriction member and the wire harness according to the present disclosure will be described below with reference to the drawings. In each drawing, for convenience of description, some parts of the configuration may be exaggerated or simplified. In addition, the dimensional proportions of each part may differ between drawings. In this specification, “perpendicular”, “parallel”, and “entire length” do not only mean strictly perpendicular, parallel, and entire length, but also include approximately perpendicular, parallel, and entire length within the range in which the effects of this embodiment are achieved. In this specification, “same” refers not only to being exactly the same, but also to cases where there is some difference between the objects being compared due to the influence of dimensional tolerances and the like. In addition, the term “tubular” as used in the description of this specification does not only refer to a tubular shape in which a peripheral wall is continuous over the entire periphery in the peripheral direction, but also includes a tubular shape formed by combining a plurality of components, and a C-shape or U-shape having a notch or the like in part of the peripheral direction. Note that “tubular” shapes include, but are not limited to, circles, ellipses, and polygons with sharp or rounded corners. In addition, in this specification, “opposing” refers to surfaces or members being at positions in front of each other, and includes not only cases where they are completely in front of each other, but also cases where they are partially in front of each other. In addition, in this specification, “opposing” includes both a case where a member other than two parts is interposed between the two parts, and a case where nothing is interposed between the two parts. Also, some of the drawings show an X-axis, a Y-axis, and a Z-axis, which are perpendicular to each other. In the following description, for convenience, the direction extending along the X-axis is referred to as the X-axis direction, the direction extending along the Y-axis is referred to as the Y-axis direction, and the direction extending along the Z-axis is referred to as the Z-axis direction. Note that the present invention is not limited to these examples, but is indicated by the claims, and all modifications within the meaning and range equivalent to the claims are intended to be encompassed therein.

### Overall Configuration of Wire Harness 10

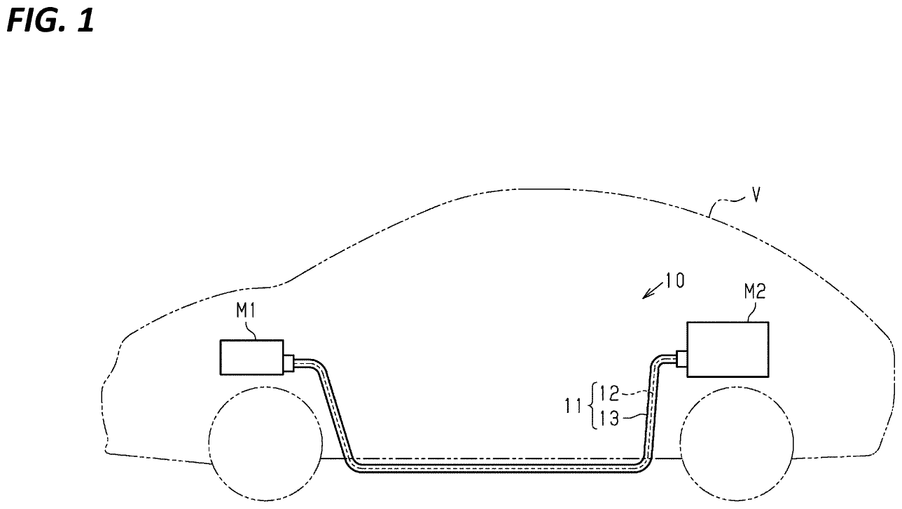

The wire harness 10 shown in FIG. 1 is, for example, mounted in a vehicle V. The vehicle V may be, for example, a hybrid vehicle or an electric vehicle. The wire harness 10 electrically connects two or more electrical devices to each other. The wire harness 10 electrically connects, for example, an inverter M1 installed at the front of the vehicle V and a high-voltage battery M2 installed rearward of the inverter M1 in the vehicle V.

The wire harness 10 includes an electric wire member 11. The electric wire member 11 includes one or more electric wires 12 and a tubular exterior member 13 that surrounds the outer periphery of the electric wires 12. The electric wire 12 is, for example, a thick electric wire having a large conductor cross-sectional area. Here, in this specification, a “thick electric wire” refers to an electric wire having a conductor cross-sectional area of 10 mm² (what is called 10 sq) or more. The exterior member 13 has, for example, an elongated tubular shape overall.

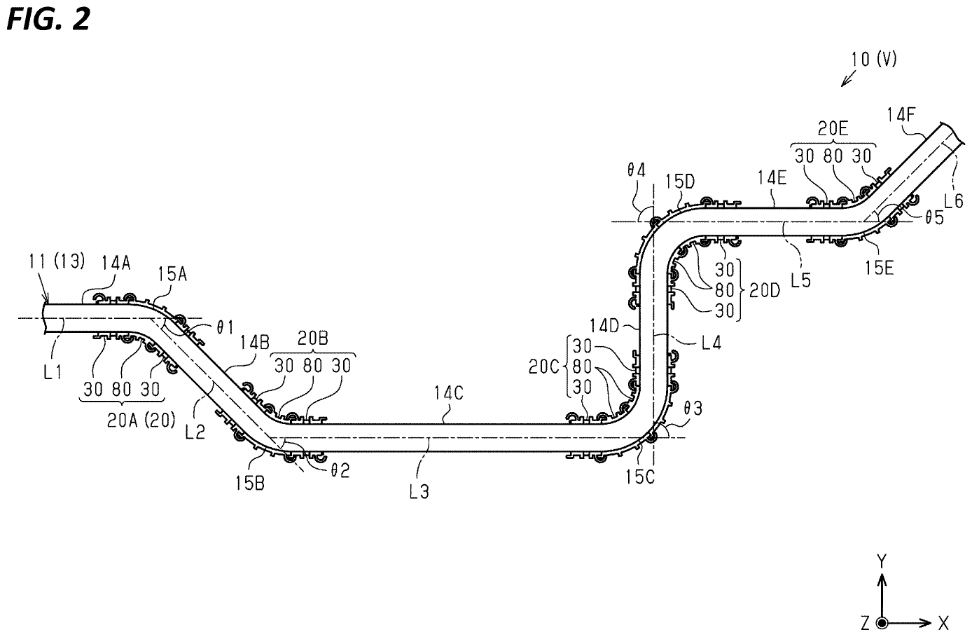

As shown in FIG. 2, when the electric wire member 11 is mounted in the vehicle V, for example, it is bent two-dimensionally or three-dimensionally. The electric wire member 11 of this embodiment has a straight portion 14A extending linearly along the X-axis direction, a bent portion 15A provided at an end portion of the straight portion 14A, and a straight portion 14B extending diagonally downward to the right in the drawing from the bent portion 15A. The electric wire member 11 has a bent portion 15B provided at an end portion of the straight portion 14B, a straight portion 14C extending linearly along the X-axis direction from the bent portion 15B, and a bent portion 15C provided at an end portion of the straight portion 14C. The electric wire member 11 has a straight portion 14D extending linearly along the Y-axis direction from the bent portion 15C, a bent portion 15D provided at an end portion of the straight portion 14D, and a straight portion 14E extending linearly along the X-axis direction from the bent portion 15D. The electric wire member 11 has a bent portion 15E provided at an end portion of the straight portion 14E, and a straight portion 14F extending diagonally upward to the right in the drawing from the bent portion 15E. In this manner, the electric wire member 11 of the present embodiment has five bent portions 15A, 15B, 15C, 15D, and 15E.

The bent portion 15A is formed, for example, so as to bend the path of the electric wire member 11 at a bending angle θ1. Here, the bending angle θ1 is the angle between a central axis L1 of the straight portion 14A and a central axis L2 of the straight portion 14B. The bent portion 15A bends the path of the electric wire member 11 such that the bending angle θ1 is 45°. The bent portion 15A is formed, for example, so as to bend the path of the electric wire member 11 to the right in the drawing with respect to the central axis L1 of the straight portion 14A. That is, the bent portion 15A is formed so as to bend the path of the electric wire member 11 to the right at a bending angle θ1 of 45° with respect to the central axis L1 of the straight portion 14A.

The bent portion 15B bends the path of the electric wire member 11 such that a bending angle θ2 between the central axis L2 of the straight portion 14B and a central axis L3 of the straight portion 14C is, for example, 45°. The bent portion 15B is formed, for example, so as to bend the path of the electric wire member 11 to the left in the drawing with respect to the central axis L2 of the straight portion 14B. That is, the bent portion 15B is formed so as to bend the path of the electric wire member 11 to the left at a bending angle θ2 of 45° with respect to the central axis L2 of the straight portion 14B. The bent portion 15C bends the path of the electric wire member 11 to the left such that a bending angle θ3 between the central axis L3 of the straight portion 14C and a central axis L4 of the straight portion 14D is 90°, for example. The bent portion 15D bends the path of the electric wire member 11 to the right such that a bending angle θ4 between the central axis L4 of the straight portion 14D and a central axis L5 of the straight portion 14E is, for example, 90°. The bent portion 15E bends the path of the electric wire member 11 to the left such that a bending angle θ5 between the central axis L5 of the straight portion 14E and a central axis L6 of the straight portion 14F is, for example, 45°.

The wire harness 10 includes one or more path restriction members 20 that restrict the path of the electric wire member 11. The path restriction members 20 are attached to the outer periphery of the electric wire member 11. The path restriction members 20 are provided at at least one of the plurality of bent portions 15A, 15B, 15C, 15D, and 15E of the electric wire member 11, and maintain the bent shape of the electric wire member 11 at the bent portions 15A, 15B, 15C, 15D, and 15E. The wire harness 10 of the present embodiment includes five path restriction members 20A, 20B, 20C, 20D, and 20E, which are provided corresponding to the five bent portions 15A, 15B, 15C, 15D, and 15E, respectively.

The plurality of path restriction members 20A, 20B, 20C, 20D, and 20E are provided, for example, spaced apart from each other in the length direction of the electric wire member 11. Each of the path restriction members 20A, 20B, 20C, 20D, and 20E includes, for example, one or more straight components 30 and one or more bent components 80.

### Configuration of Path Restriction Member 20A

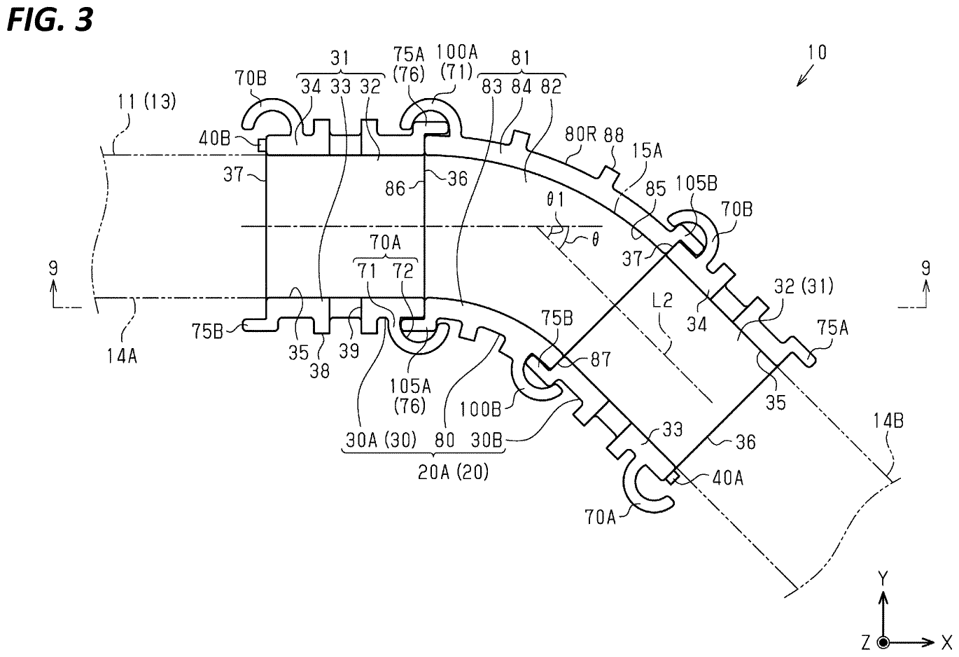

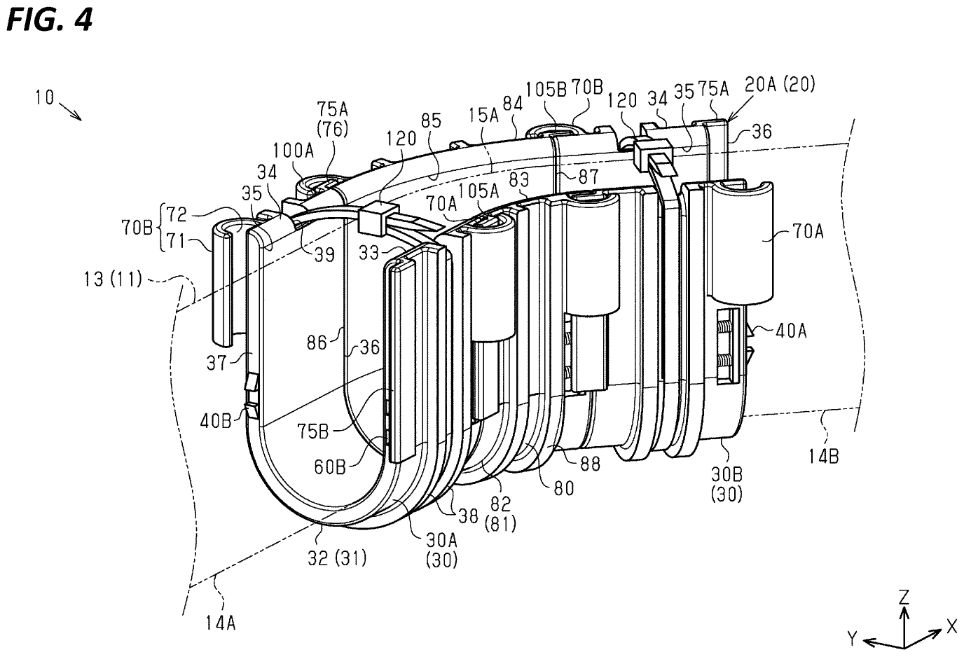

As shown in FIGS. 3 and 4, the path restriction member 20A is configured such that, along the length direction of the electric wire member 11, a straight component 30, a bent component 80, and a straight component 30 are arranged in the stated order. In the following description, for convenience, the straight component 30 located to the left of the bent component 80 in the drawing may be referred to as a “straight component 30A”, and the straight component 30 located to the right of the bent component 80 in the drawing may be referred to as a “straight component 30B”.

Each of the straight components 30A and 30B and the bent component 80 holds the exterior member 13. The exterior member 13 is less likely to bend than in a state where, for example, the straight components 30A and 30B and the bent component 80 are not attached. The straight components 30A and 30B and the bent component 80 are made of, for example, metal or resin. In this embodiment, the straight components 30A and 30B and the bent component 80 are made of resin.

The straight component 30A is attached to the outer periphery of the exterior member 13 at the straight portion 14A of the path of the electric wire member 11, for example. The straight component 30B is attached to the outer periphery of the exterior member 13 at the straight portion 14B of the path of the electric wire member 11, for example. The straight components 30A and 30B restrict the path of the electric wire member 11 in the straight portions 14A and 14B, respectively.

The bent component 80 is attached to the outer periphery of the exterior member 13 at the bent portion 15A of the path of the electric wire member 11, for example. The bent component 80 restricts the path of the electric wire member 11 at the bent portion 15A.

### Configuration of Straight Components 30A and 30B

Next, a specific structure of the straight component 30A will be described. Note that since the straight component 30B has the same structure as the straight component 30A, configurations that are the same as those of the straight component 30A are denoted by the same reference numerals, and detailed description thereof is omitted here.

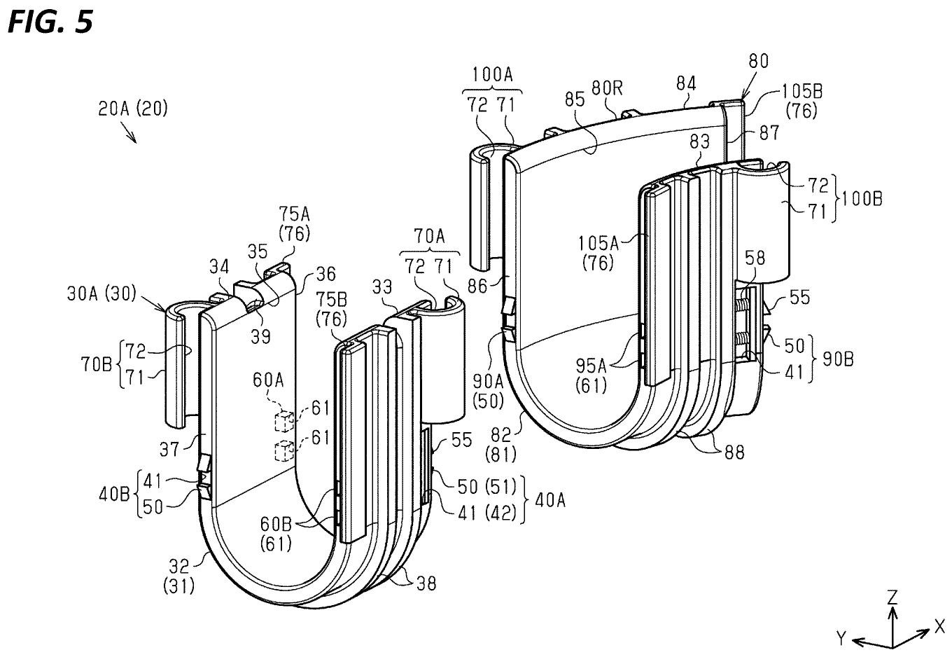

As shown in FIG. 5, the straight component 30A includes a holding portion 31, two coupling portions 40A and 40B having the same structure as each other, and two coupling portions 60A and 60B having the same structure as each other. The straight component 30A includes two engagement portions 70A and 70B having the same structure as each other, and two engagement portions 75A and 75B having the same structure as each other. The straight component 30A is formed, for example, in a shape that is point-symmetric about a central axis of the straight component 30A that passes through the center of the straight component 30A in the XY plane and extends in the Z-axis direction.

As shown in FIG. 4, the holding portion 31 holds the electric wire member 11. The holding portion 31 has a tubular shape covering the outer periphery of the exterior member 13 at a portion in the peripheral direction of the exterior member 13. The cross-sectional shape of the holding portion 31 is U-shaped overall. The holding portion 31 is formed in a shape that extends linearly in one direction.

As shown in FIG. 5, the holding portion 31 has, for example, a bottom wall 32, a side wall 33 protruding from a first side edge of the bottom wall 32, and a side wall 34 protruding from a second side edge of the bottom wall 32. The bottom wall 32 and the side walls 33 and 34 each extend linearly along the X-axis direction, for example. The cross-sectional shape of the bottom wall 32 is, for example, arc-shaped.

Each of the side walls 33 and 34 is formed integrally and continuously with the bottom wall 32. The side walls 33 and 34 protrude, for example, toward the Z-axis direction from both edges of the bottom wall 32 in the width direction (here, the Y-axis direction). The two side walls 33 and 34 oppose each other in the width direction of the bottom wall 32, for example. Each of the side walls 33 and 34 is formed, for example, in a plate shape. Each of the side walls 33 and 34 extends linearly along the Z-axis direction, for example.

The straight component 30A has an insertion opening 35 that is open in a direction perpendicular to the axial direction of the straight component 30A. The insertion opening 35 is constituted by a gap between an upper end of the side wall 33 and an upper end of the side wall 34. The insertion opening 35 extends, for example, along the axial direction of the straight component 30A over the entire length in the axial direction of the straight component 30A. That is, the insertion opening 35 is open at both ends in the axial direction of the straight component 30A.

The straight component 30A has an end portion 36 in the axial direction of the straight component 30A and an end portion 37 provided on the side opposite to the end portion 36. The end portion 36 is, for example, the end portion opposing the bent component 80.

The straight component 30A has, for example, one or more (in the present embodiment, two) reinforcing ribs 38 provided on the outer peripheral surface of the holding portion 31. The reinforcing ribs 38 are formed, for example, over the entire periphery in the peripheral direction of the outer peripheral surface of the holding portion 31. Each reinforcing rib 38 protrudes toward an outer side in a radial direction of the holding portion 31 from the outer peripheral surface of the holding portion 31. By providing the reinforcing ribs 38, the bending rigidity of the straight component 30A can be improved.

The straight component 30A has, for example, one or more groove portions 39 provided on the outer peripheral surface of the holding portion 31. The groove portions 39 are provided between the two reinforcing ribs 38 in the axial direction of the straight component 30. The groove portions 39 are formed so as to be recessed downward from the upper surfaces of the side walls 33 and 34.

The coupling portion 40A is provided on the side wall 33 at the end portion 36. The coupling portion 40B is provided on the side wall 34 at the end portion 37. The coupling portion 60A is provided on the side wall 34 at the end portion 36. The coupling portion 60B is provided on the side wall 33 at the end portion 37. The coupling portions 40B and 60B provided at the end portion 37 are formed in a structure that is a 180-degree rotation of the structure of the coupling portions 40A and 60A provided at the end portion 36.

The engagement portion 70A is provided on the side wall 33 at the end portion 36. The engagement portion 70B is provided on the side wall 34 at the end portion 37. The engagement portion 75A is provided on the side wall 34 at the end portion 36. The engagement portion 75B is provided on the side wall 33 at the end portion 37. The engagement portions 70B and 75B provided at the end portion 37 are formed in a structure that is a 180-degree rotation of the structure of the engagement portions 70A and 75A provided at the end portion 36.

Next, a specific structure of the coupling portion 40A will be described. Note that since the coupling portion 40B has the same structure as the coupling portion 40A, configurations that are the same as those of the coupling portion 40A are denoted by the same reference numerals, and detailed description thereof will be omitted here.

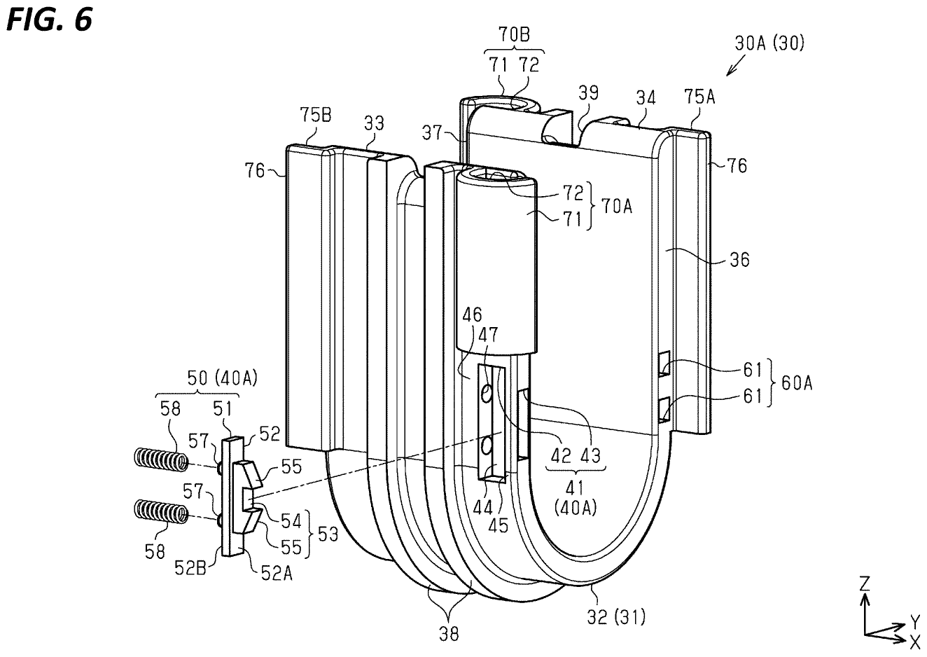

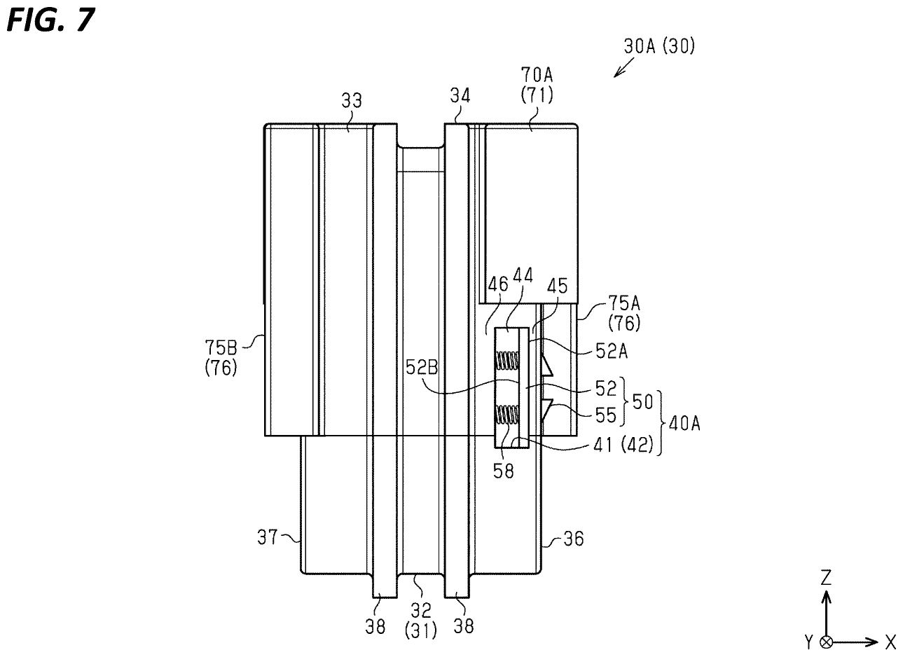

As shown in FIGS. 6 and 7, the coupling portion 40A includes an accommodation portion 41 provided in the holding portion 31 and a latch portion 50 accommodated in the accommodation portion 41. The latch portion 50 is, for example, a separate component from the holding portion 31.

As shown in FIG. 6, the accommodation portion 41 has, for example, a first recess 42 formed on the outer peripheral surface of the side wall 33 at the end portion 36, and a second recess 43 formed on the end surface in the axial direction of the side wall 33 at the end portion 36.

The first recess 42 is formed so as to be recessed from the outer peripheral surface of the side wall 33 at the end portion 36 toward the inner side in the radial direction of the holding portion 31. The first recess 42 is formed, for example, so as not to penetrate through the side wall 33 in the radial direction. In other words, the accommodation portion 41 has an end wall 44 that closes the opening on the inner side in the radial direction of the holding portion 31 in the first recess 42. In addition, the accommodation portion 41 has a first peripheral wall 45 that forms the inner surface of the first recess 42 and in which the second recess 43 is formed, and a second peripheral wall 46 that forms the inner surface of the first recess 42 and opposes the first peripheral wall 45. The inner surface of the first peripheral wall 45 and the inner surface of the second peripheral wall 46 oppose each other in the X-axis direction. The accommodation portion 41 has one or more (two in this embodiment) third recesses 47 formed on the inner surface of the second peripheral wall 46. The two third recesses 47 are spaced apart from each other in the Z-axis direction. Each third recess 47 is formed so as to be recessed from the inner surface of the second peripheral wall 46 along the axial direction of the side wall 33 (here, the X-axis direction).

The second recess 43 is recessed from the end surface in the axial direction of the side wall 33 at the end portion 36 toward the first recess 42 and is formed to be in communication with the first recess 42. The second recess 43 is formed to penetrate through the first peripheral wall 45 in the X-axis direction. The second recess 43 is provided in only an intermediate portion in the thickness direction of the side wall 33.

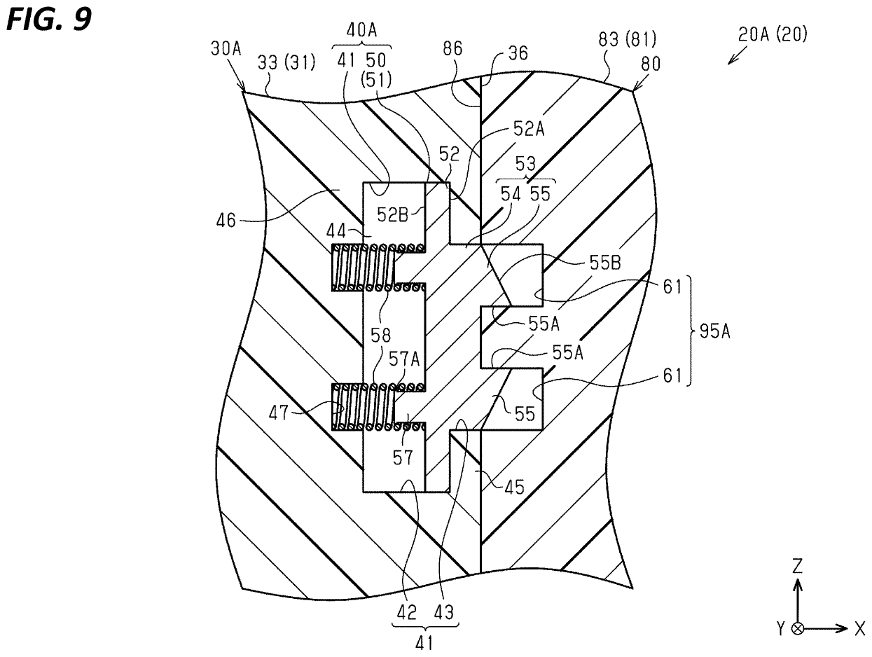

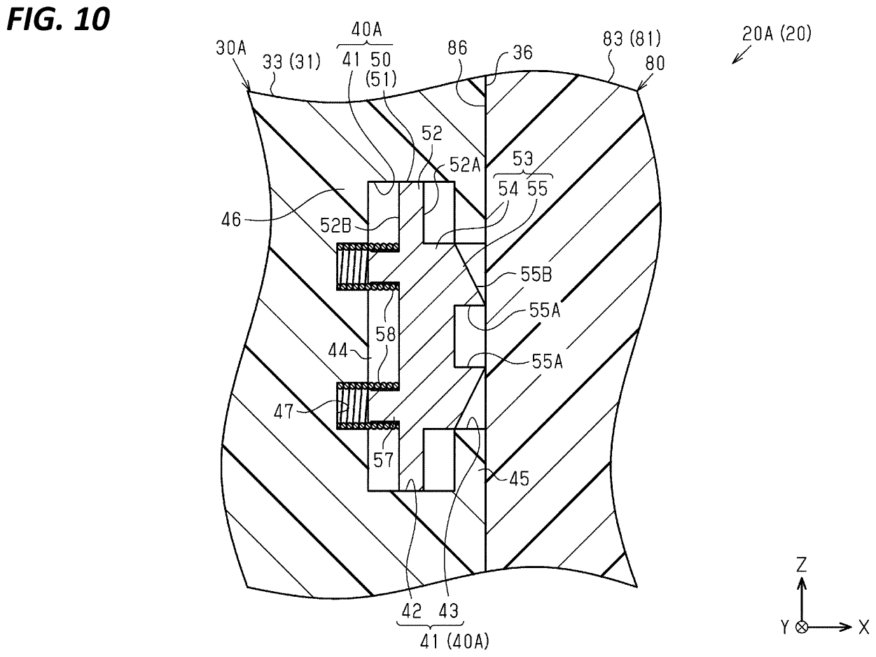

As shown in FIG. 7, the latch portion 50 is accommodated in the accommodation portion 41 and is provided such that a portion of the latch portion 50 protrudes outward relative to the end surface in the axial direction of the side wall 33 at the end portion 36. The latch portion 50 is configured to be displaceable between a first orientation (see FIG. 9) in which it can engage with a partner coupling portion, and a second orientation (see FIG. 10) in which it can release the engagement with the partner coupling portion.

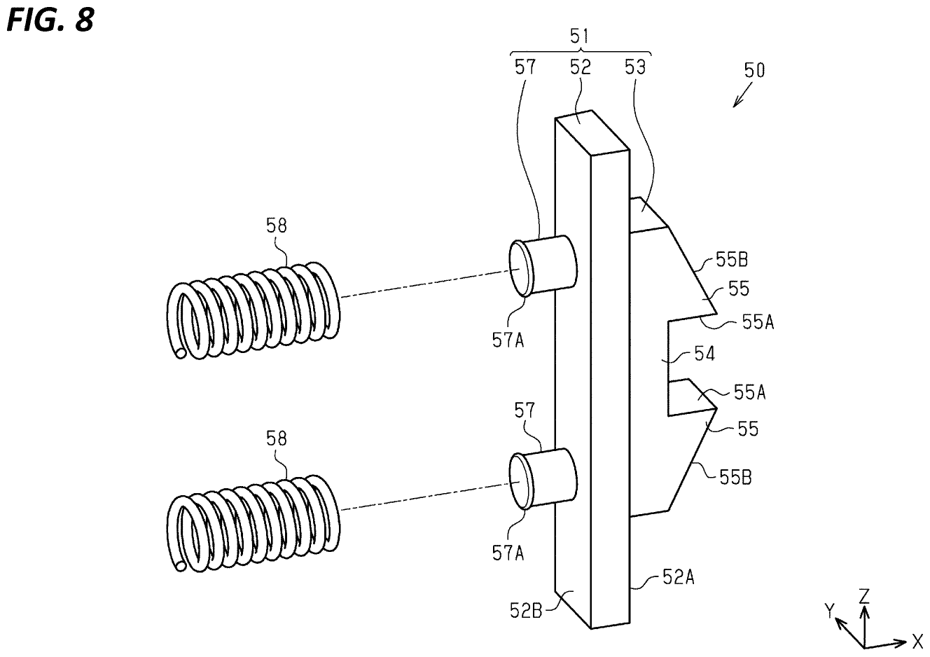

As shown in FIG. 8, the latch portion 50 includes a latch body 51 and one or more (two in this embodiment) biasing members 58. The biasing member 58 is a separate component from the latch body 51.

The latch body 51 has a base portion 52 having a first surface 52A and a second surface 52B, an engagement projection 53 provided on the first surface 52A of the base portion 52, and one or more (in this embodiment, two) columnar projections 57 provided on the second surface 52B of the base portion 52. The latch body 51 is made of, for example, metal or resin. The latch body 51 of this embodiment is made of resin.

The base portion 52 is formed in, for example, a cuboid shape. As shown in FIG. 7, the first surface 52A is engageable with the inner surface of the first peripheral wall 45 in the X-axis direction. The second surface 52B opposes the inner surface of the second peripheral wall 46. The base portion 52 is formed to a size that cannot be inserted into the second recess 43.

As shown in FIG. 8, the engagement projection 53 has a projection base portion 54 that protrudes from the first surface 52A of the base portion 52 along the X-axis direction, and one or more (in this embodiment, two) protruding portions 55 that protrude from the distal end surface of the projection base portion 54 along the X-axis direction. The projection base portion 54 is formed in, for example, a cuboid shape. The projection base portion 54 is formed slightly smaller than the base portion 52.

As shown in FIG. 9, the two protruding portions 55 are spaced apart from each other in the peripheral direction (here, the Z-axis direction) of the path restriction member 20A. Each protruding portion 55 has an engagement surface 55A and a distal end surface 55B. The two engagement surfaces 55A oppose each other in the Z-axis direction. The engagement surface 55A is formed, for example, parallel to the XY plane. The distal end surface 55B is formed as an inclined surface that is inclined such that the protrusion amount of the protruding portion 55 from the projection base portion 54 decreases as the distance from the other protruding portion 55 increases. The planar shape of the protruding portion 55 as viewed from the Y-axis direction is, for example, triangular.

As shown in FIG. 8, the two columnar projections 57 are spaced apart from each other in the Z-axis direction. Each of the columnar projections 57 is formed in a columnar shape that protrudes from the second surface 52B of the base portion 52 along the X-axis direction. Each of the columnar projections 57 in this embodiment is formed in a columnar shape. Each of the columnar projections 57 has a flange portion 57A at its distal end. The flange portion 57A protrudes to an outer side in the radial direction of the columnar projection 57 from the outer peripheral surface of the columnar projection 57. The flange portion 57A is formed continuously over the entire periphery in the peripheral direction of the columnar projection 57.

In this embodiment, each of the biasing members 58 is a coil spring. Each of the biasing members 58 is attached to the outer periphery of a corresponding columnar projection 57. Each of the biasing members 58 is provided so as to surround the outer periphery of a corresponding columnar projection 57. Each of the biasing members 58 extends along the X-axis direction.

As shown in FIG. 9, the distal end portion of each of the biasing members 58 is accommodated in the third recess 47 of the accommodation portion 41. The distal end portion of each of the biasing members 58 is in contact with the bottom surface of the third recess 47. The base end portion of each biasing member 58 is in contact with the second surface 52B of the base portion 52. In the first orientation, each of the biasing members 58 biases the latch body 51 toward the inner surface of the first peripheral wall 45. As a result, in the first orientation, the first surface 52A of the base portion 52 of the latch body 51 is pressed against the inner surface of the first peripheral wall 45. In the first orientation, the protruding portion 55 of the latch body 51 protrudes outward relative to the end surface in the axial direction of the side wall 33 at the end portion 36.

As shown in FIG. 10, when the protruding portion 55 of the latch body 51 is pressed toward the second peripheral wall 46, each of the biasing members 58 is compressed between the second surface 52B of the base portion 52 and the bottom surface of the third recess 47, and the latch portion 50 enters the second orientation. In the second orientation, the first surface 52A of the base portion 52 is separated from the inner surface of the first peripheral wall 45, and the protruding portion 55 is accommodated inside the second recess 43. That is, in the second orientation, the protruding portion 55 does not protrude outward relative to the end surface in the axial direction of the side wall 33 at the end portion 36.

Next, the specific structure of the coupling portion 60A will be described with reference to FIG. 6. Note that the coupling portion 60B (see FIG. 5) has the same structure as the coupling portion 60A, and therefore the same configurations as those of the coupling portion 60A are denoted by the same reference numerals, and detailed description thereof will be omitted here.

As shown in FIG. 6, the coupling portion 60A has one or more (in this embodiment, two) fitting recesses 61 recessed from the end surface in the axial direction of the side wall 34 at the end portion 36 toward the end portion 37. The two fitting recesses 61 are spaced apart from each other in the Z-axis direction. The two fitting recesses 61 are provided at positions in the Z-axis direction where they can be respectively fitted into the two protruding portions 55. Each of the fitting recesses 61 is formed to a size that can fit into the protruding portion 55. Each of the fitting recesses 61 is provided, for example, at only an intermediate portion in the thickness direction of the side wall 34.

Next, the specific structure of the engagement portion 75A will be described. Here, since the engagement portion 75B has the same structure as the engagement portion 75A, the same configurations as those of the engagement portion 75A are denoted by the same reference numerals, and detailed description thereof will be omitted here. Note that the structure of the engagement portion 75A will be described with reference to the engagement portion 75B as well.

The engagement portion 75A has, for example, an engagement wall 76 provided on the outer peripheral surface of the side wall 34. The engagement wall 76 is formed in one piece with, for example, the outer peripheral surface of the side wall 34. The engagement wall 76 protrudes to the outer side in the radial direction of the holding portion 31 from the outer peripheral surface of the side wall 34. The engagement wall 76 protrudes outward of the holding portion 31 from the outer peripheral surface of the side wall 34 in the axial direction of the holding portion 31. That is, the engagement wall 76 protrudes outward of the holding portion 31 relative to the end surface in the axial direction of the side wall 34 at the end portion 36. As shown in FIG. 3, the engagement wall 76 is provided so as to be able to cover, for example, the outer peripheral surface of the bent component 80 from the outer side in the radial direction of the holding portion 31.

As shown in FIG. 6, the engagement wall 76 is formed, for example, in a plate shape. The engagement wall 76 is formed in a plate shape that extends in the height direction of the side wall 34 and in the axial direction of the holding portion 31. The engagement wall 76 extends downward from the upper end of the side wall 34, for example. The engagement wall 76 extends downward relative to the fitting recess 61 in the Z-axis direction.

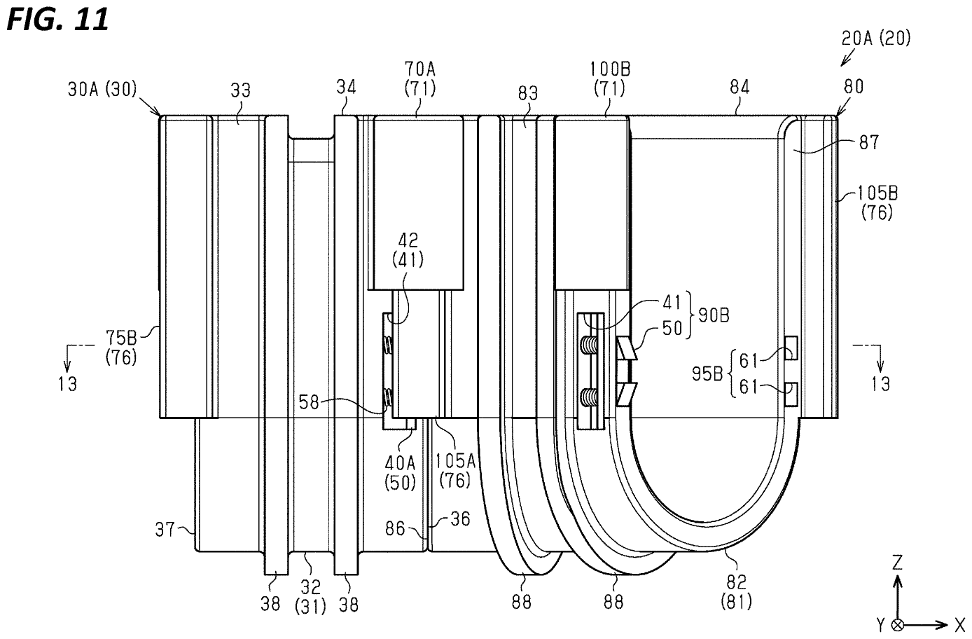

As shown in FIG. 11, the engagement wall 76 extends to a position above the lower end of the first recess 42 in the Z-axis direction, for example. The engagement wall 76 is formed so as to be able to cover, for example, a portion of the opening of the first recess 42.

Next, the specific structure of the engagement portion 70A will be described. Here, since the engagement portion 70B has the same structure as the engagement portion 70A, the same components as those of the engagement portion 70A are denoted by the same reference numerals, and detailed description thereof will be omitted here. Note that the structure of the engagement portion 70A will be described with reference to the engagement portion 70B as well.

The engagement portion 70A has a grip portion 71 provided on the outer peripheral surface of the side wall 33. The grip portion 71 is formed integrally and continuously with the outer peripheral surface of the side wall 33. The grip portion 71 is formed so as to be able to grip the engagement wall 76.

As shown in FIG. 5, the grip portion 71 is formed, for example, in the shape of a half cylinder overall. The grip portion 71 is formed, for example, in the shape of a half cylinder having a groove portion 72. The grip portion 71 extends along the height direction of the side wall 33 (here, the Z-axis direction). The grip portion 71 extends downward from the upper end of the side wall 33, for example. The grip portion 71 extends to a position above the first recess 42 in the Z-axis direction. The length of the grip portion 71 along the Z-axis direction is, for example, smaller than the length of the engagement wall 76 along the Z-axis direction.

The grip portion 71 protrudes outward in the radial direction of the holding portion 31 from the outer peripheral surface of the side wall 33. The grip portion 71 protrudes outward of the holding portion 31 from the outer peripheral surface of the side wall 33 toward the axial direction of the holding portion 31. The grip portion 71 protrudes toward the outer side in the axial direction of the holding portion 31 relative to the end surface in the axial direction of the side wall 33 at the end portion 36. As shown in FIG. 3, the grip portion 71 protrudes in an arc shape from the outer peripheral surface of the side wall 33 at the end portion 36 toward the outer side in the radial direction of the holding portion 31 and the bent component 80. The outer peripheral surface of the grip portion 71 is formed such that its planar shape as viewed from the Z-axis direction is arc-shaped.

The groove portion 72 is formed so as to be recessed from the inner surface of the grip portion 71 toward the outer side in the radial direction of the holding portion 31. The groove portion 72 is formed to a size that allows the engagement wall 76 to be accommodated therein. The inner surface of the groove portion 72 is formed such that, for example, its planar shape as viewed from the Z-axis direction is arc-shaped. The groove portion 72 extends, for example, along the axial direction of the grip portion 71 (here, the Z-axis direction) over the entire length in the axial direction of the grip portion 71.

### Configuration of Bent Component 80

Next, the specific structure of the bent component 80 will be described.

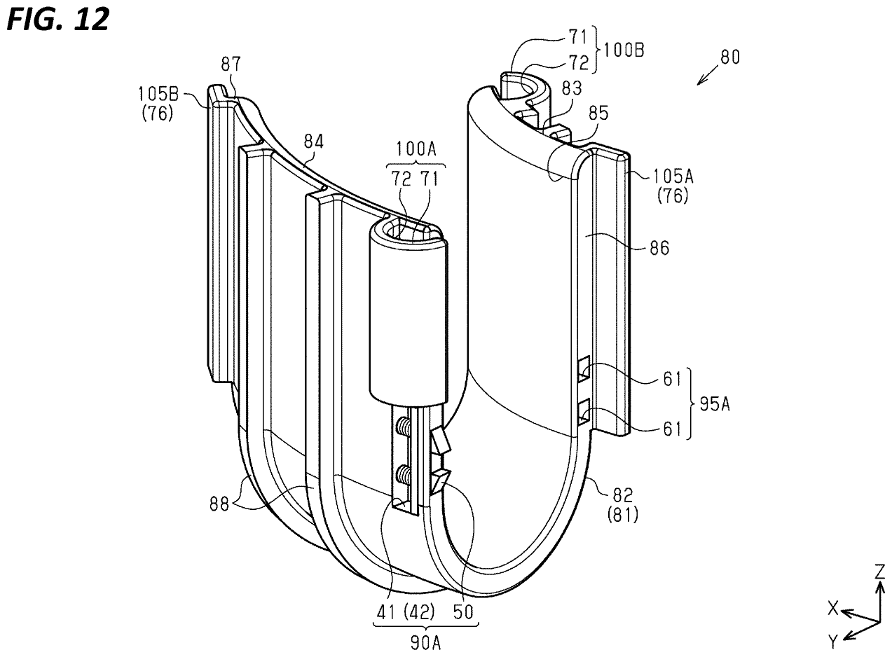

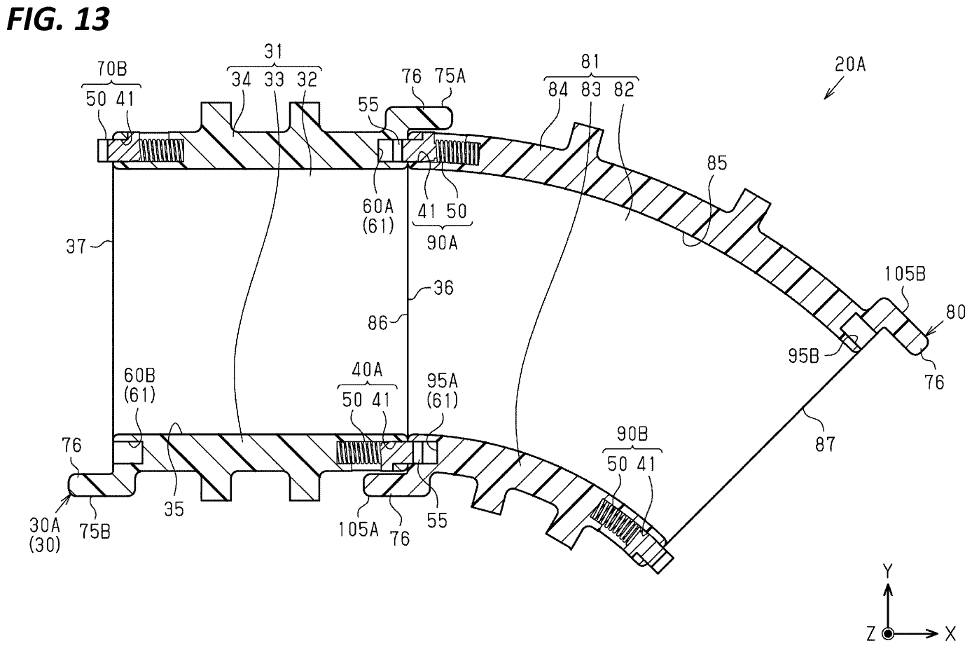

As shown in FIGS. 12 and 13, the bent component 80 includes a holding portion 81. As shown in FIG. 13, the bent component 80 includes two coupling portions 90A and 90B having the same structure as each other, and two coupling portions 95A and 95B having the same structure as each other. As shown in FIG. 12, the bent component 80 includes two engagement portions 100A and 100B having the same structure as each other, and two engagement portions 105A and 105B having the same structure as each other.

As shown in FIG. 4, the holding portion 81 holds the electric wire member 11. The holding portion 81 is tubular and covers the outer periphery of the exterior member 13 at a portion in the peripheral direction of the exterior member 13. The transverse cross-sectional shape of the holding portion 81 is U-shaped overall. The transverse cross-sectional shape of the holding portion 81 is, for example, formed to have the same shape and size as the transverse cross-sectional shape of the holding portion 31. As shown in FIG. 3, the holding portion 81 is formed in a bent shape having a bent portion 80R that is bent at a predetermined bending angle θ. In this embodiment, the bending angle θ of the bent portion 80R is set to 45°. The axial direction of the tubular holding portion 81 extends so as to bend at a predetermined bending angle θ.

The holding portion 81 has, for example, a bottom wall 82, a side wall 83 protruding from a third side edge of the bottom wall 82, and a side wall 84 protruding from a fourth side edge of the bottom wall 82. The bottom wall 82 and the side walls 83 and 84 each extend so as to bend at a predetermined bending angle θ in a plan view as viewed from the Z-axis direction, for example. The bottom wall 82 and the side walls 83 and 84 are each formed to be curved in an arc shape in a plan view as viewed from the Z-axis direction. As shown in FIG. 5, the transverse cross-sectional shape of the bottom wall 82 is formed, for example, in an arc shape.

Each of the side walls 83 and 84 is formed integrally and continuously with the bottom wall 82. The side walls 83 and 84 protrude in the Z-axis direction from both edges in the width direction of the bottom wall 82 (here, the Y-axis direction), for example. The two side walls 83 and 84 oppose each other in the width direction of the bottom wall 82, for example.

As shown in FIG. 3, the side wall 83 is provided, for example, on the bend inner side of the bent portion 80R out of the two edges in the width direction of the bottom wall 82. The side wall 84 is provided, for example, on the bend outer side of the bent portion 80R out of the two edges in the width direction of the bottom wall 82. The inner and outer peripheral surfaces of the side walls 83 and 84 are formed so as to curve in an arc shape in a plan view from the Z-axis direction. The length of the side wall 83 along the axial direction of the holding portion 81 is smaller than the length of the side wall 84 along the axial direction of the holding portion 81.

As shown in FIG. 5, the bent component 80 has an insertion opening 85 that is open in a direction perpendicular to the axial direction of the bent component 80. The insertion opening 85 is constituted by a gap between an upper end of the side wall 83 and an upper end of the side wall 84. The insertion opening 85 extends, for example, along the axial direction of the bent component 80 over the entire length in the axial direction of the bent component 80. That is, the insertion opening 85 is formed so as to be open at both ends in the axial direction of the bent component 80.

The bent component 80 has an end portion 86 in the axial direction of the bent component 80 and an end portion 87 provided on a side opposite to the end portion 86. The end portion 86 is the end portion opposing the straight component 30A.

The bent component 80 has, for example, one or more (in this embodiment, two) reinforcing ribs 88 provided on the outer peripheral surface of the holding portion 81. Each reinforcing rib 88 is formed, for example, around the entire periphery in the peripheral direction of the outer peripheral surface of the holding portion 81. Each reinforcing rib 88 protrudes to the outer side in the radial direction of the holding portion 81 from the outer peripheral surface of the holding portion 81. By providing the reinforcing ribs 88, the bending rigidity of the bent component 80 can be improved.

As shown in FIG. 13, the coupling portion 90A is provided on the side wall 84 at the end portion 86. The coupling portion 90B is provided on the side wall 83 at the end portion 87. The coupling portion 95A is provided on the side wall 83 at the end portion 86. The coupling portion 95B is provided on the side wall 84 at the end portion 87. The coupling portions 90B and 95B provided at the end portion 87 are formed in a structure that is a 180-degree rotation of the structure of the coupling portions 90A and 95A provided at the end portion 86.

Here, each of the coupling portions 90A and 90B has the same structure as the coupling portion 40A of the straight component 30A, that is, the accommodation portion 41 and the latch portion 50. Each of the coupling portions 95A and 95B has the same structure as the coupling portion 60A of the straight component 30A, that is, the fitting recess 61.

As shown in FIG. 5, the engagement portion 100A is provided on the side wall 84 at the end portion 86. The engagement portion 100B is provided on the side wall 83 at the end portion 87. The engagement portion 105A is provided on the side wall 83 at the end portion 86. The engagement portion 105B is provided on the side wall 84 at the end portion 87. The engagement portions 100B and 105B provided at the end portion 87 are formed in a structure that is a 180-degree rotation of the engagement portions 100A and 105A provided at the end portion 86.

Here, each of the engagement portions 100A and 100B has the same structure as the engagement portion 70A of the straight component 30A, that is, a grip portion 71 having a groove portion 72. Each of the engagement portions 105A and 105B has the same structure as the engagement portion 75A of the straight component 30A, that is, the engagement wall 76.

As shown in FIGS. 4, 9, and 13, the straight component 30A is coupled to the end portion 86 in the axial direction of the bent component 80. More specifically, as shown in FIG. 9, the coupling portion 40A of the straight component 30A and the coupling portion 95A of the bent component 80 are coupled to each other. Specifically, the two protruding portions 55 on the latch portion 50 of the coupling portion 40A are respectively fitted into the two fitting recesses 61 on the coupling portion 95A. The engagement surfaces 55A of the protruding portions 55 of the coupling portion 40A and the inner surface of the fitting recess 61 of the coupling portion 95A are engaged with each other in the peripheral direction (here, the Z-axis direction) of the path restriction member 20A. Similarly, as shown in FIG. 13, the coupling portion 60A of the straight component 30A and the coupling portion 90A of the bent component 80 are coupled to each other. Specifically, the protruding portion 55 of the latch portion 50 of the coupling portion 90A is fitted into the fitting recess 61 of the coupling portion 60A. Then, the protruding portion 55 of the coupling portion 90A and the fitting recess 61 of the coupling portion 60A are engaged with each other in the peripheral direction of the path restriction member 20A. As a result, it is possible to suppress relative movement of the bent component 80 with respect to the straight component 30A in the peripheral direction of the path restriction member 20A.

Furthermore, as shown in FIG. 3, the engagement wall 76 of the engagement portion 75A of the straight component 30A is gripped by the grip portion 71 of the engagement portion 100A of the bent component 80. Then, the outer peripheral surface of the engagement wall 76 of the engagement portion 75A and the inner peripheral surface of the grip portion 71 of the engagement portion 100A are engaged with each other in the axial direction of the path restriction member 20A. Similarly, the inner peripheral surface of the grip portion 71 of the engagement portion 70A of the straight component 30A and the engagement wall 76 of the engagement portion 105A of the bent component 80 are engaged with each other in the axial direction of the path restriction member 20A. As a result, it is possible to suppress relative movement of the bent component 80 with respect to the straight component 30A in the axial direction of the path restriction member 20A. At this time, as shown in FIG. 11, the engagement wall 76 of the engagement portion 105A is provided so as to cover a portion of the opening of the first recess 42 of the coupling portion 40A, and is provided so as to expose a portion of the opening of the first recess 42 of the coupling portion 40A. As a result, it is possible to prevent the latch portion 50 of the coupling portion 40A from coming out of the first recess 42, and it is possible to check the orientation of the latch portion 50 within the first recess 42.

As shown in FIG. 3, the straight component 30B is coupled to the end portion 87 of the bent component 80 in the same manner as the straight component 30A.

Here, in the path restriction member 20A in a state in which the straight components 30A and 30B and the bent component 80 are coupled to each other, the insertion opening 35 of the straight component 30A, the insertion opening 85 of the bent component 80, and the insertion opening 35 of the straight component 30B are in communication with each other.

As shown in FIG. 4, the wire harness 10 has a slide restricting member 120 that restricts sliding movement of the path restriction member 20A in the length direction of the exterior member 13, for example. As the slide restricting member 120, for example, a cable tie, a crimping ring, or an adhesive tape can be used. The slide restricting member 120 of this embodiment is a cable tie. The slide restricting member 120 is provided for each of the straight components 30A and 30B. The slide restricting member 120 is provided so as to be accommodated in, for example, the groove portion 39 of each of the straight components 30A and 30B. At this time, the groove portion 39 restricts the slide restricting member 120 from moving relative to the straight component 30 in the axial direction of the straight component 30. The slide restricting member 120 is wrapped around, for example, the outer peripheral surfaces of the straight components 30A and 30B and the outer peripheral surface of the exterior member 13 exposed from the insertion opening 35. Note that, although not shown in the drawings, the slide restricting member 120 is provided also for the path restriction members 20B, 20C, 20D, and 20E shown in FIG. 2.

(Configuration of Path Restriction Members 20B, 20C, 20D, and 20E) As shown in FIG. 2, the path restriction member 20B is configured such that, along the length direction of the electric wire member 11, a straight component 30, a bent component 80, and a straight component 30 are arranged in this order. The straight components 30 and the bent component 80 in the path restriction member 20B have the same configurations as the straight components 30 and the bent component 80 in the path restriction member 20A, respectively. However, the path restriction member 20B is disposed such that the structure of the path restriction member 20A is rotated by 180 degrees. In other words, the bent components 80 can be used in common for the bent portion 15A, which is a right bent portion, and the bent portion 15B, which is a left bent portion. That is, the bent components 80 having the same configuration can be used in common for the bent portion 15A that is the right bent portion and the bent portion 15B that is the left bent portion.

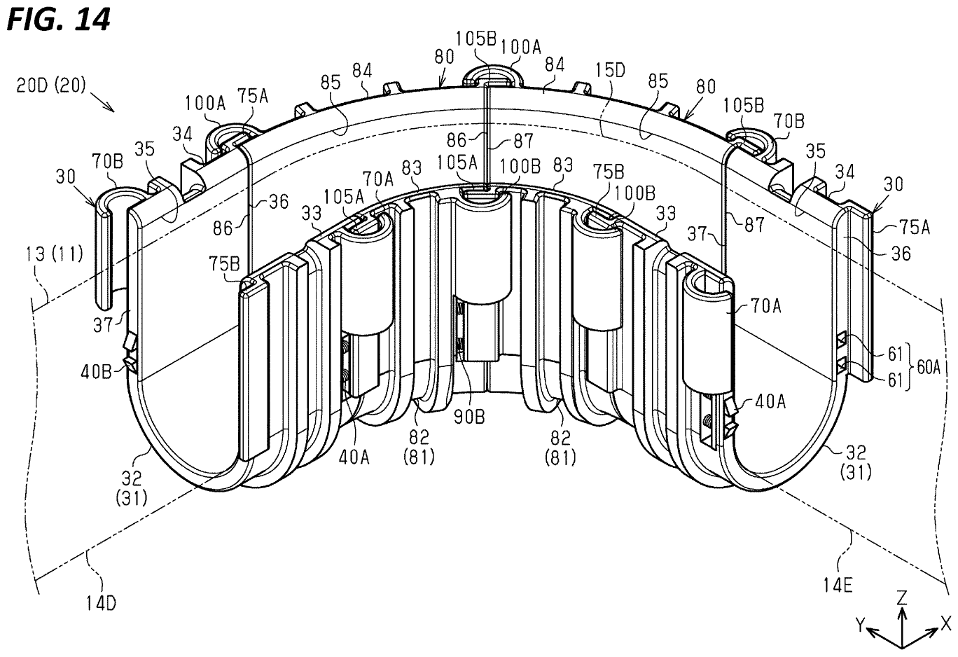

As shown in FIG. 14, the path restriction member 20D is configured such that, along the length direction of the electric wire member 11, a straight component 30, a bent component 80, a bent component 80, and a straight component 30 are arranged in this order. The straight components 30 and the bent components 80 in the path restriction member 20D have the same configurations as the straight components 30 and the bent component 80 in the path restriction member 20A, respectively. The coupling between the two bent components 80 can be performed in the same manner as the coupling between the straight component 30 and the bent component 80. The two bent components 80 are coupled in a state in which, for example, the end portion 87 of one bent component 80 (first bent component) and the end portion 86 of one bent component 80 (second bent component) oppose each other. As shown in FIG. 2, in the path restriction member 20D provided for the bent portion 15D having a bending angle θ4 of 90°, two bent components 80 are connected in series to adjust the bending angle of the path restriction member 20D.

The path restriction member 20C is configured such that a straight component 30, a bent component 80, a bent component 80, and a straight component 30 are arranged in this order along the length direction of the electric wire member 11. The path restriction member 20C is disposed such that the structure of the path restriction member 20D is rotated by 180 degrees.

The path restriction member 20E is configured such that a straight component 30, a bent component 80, and a straight component 30 are arranged in this order along the length direction of the electric wire member 11. The path restriction member 20E is disposed such that the structure of the path restriction member 20A is rotated 135° clockwise.

### Method for Manufacturing Path Restriction Member 20A

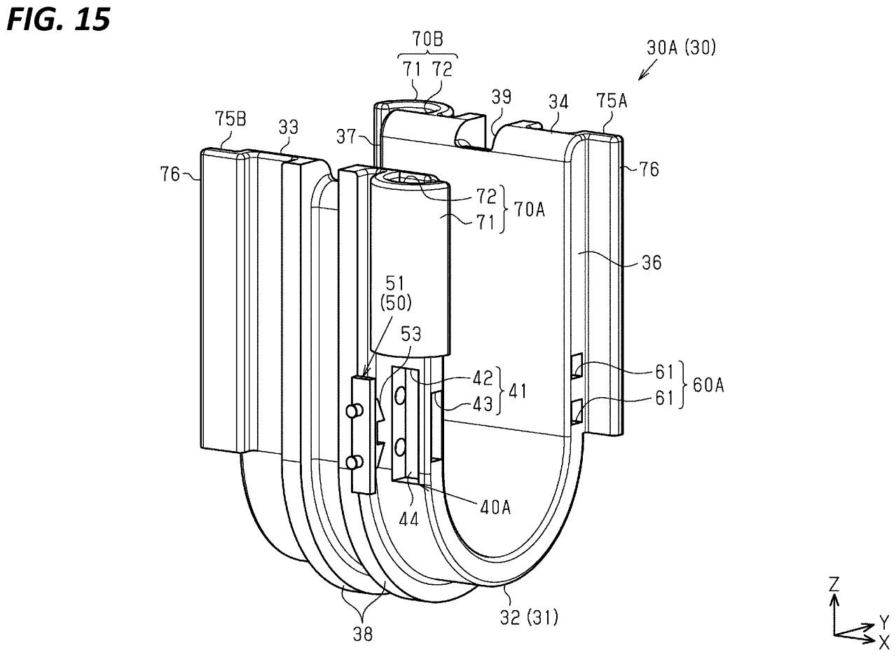

Next, a method for manufacturing the path restriction member 20A will be described with reference to FIGS. 15 to 22. First, a method for attaching the latch portion 50 to the accommodation portion 41 of the coupling portion 40A of the straight component 30A will be described.

In the step shown in FIG. 15, the latch body 51 is inserted into the first recess 42 of the accommodation portion 41 with the distal end of the engagement projection 53 on the latch body 51 of the latch portion 50 facing the end wall 44 of the accommodation portion 41 of the coupling portion 40A.

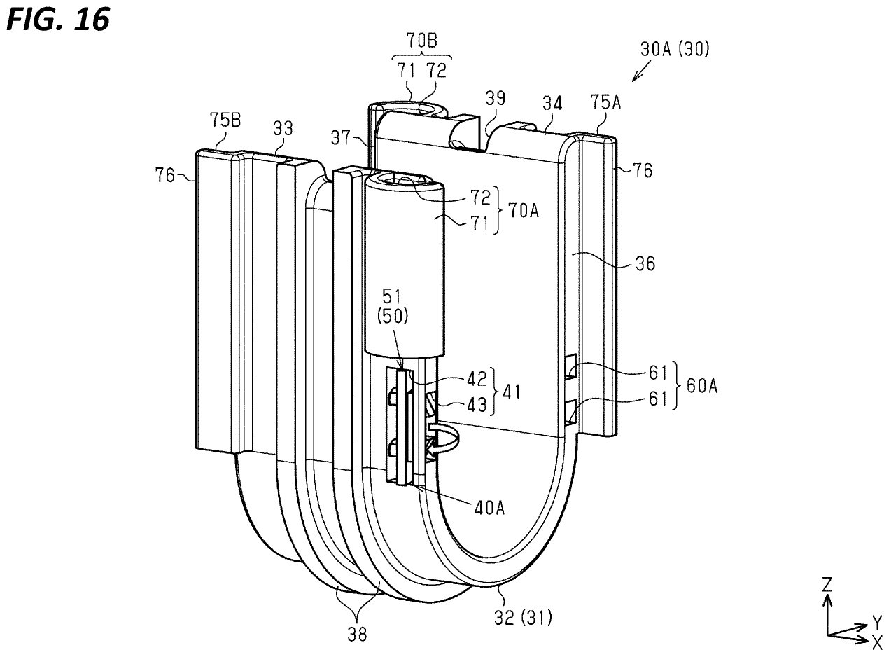

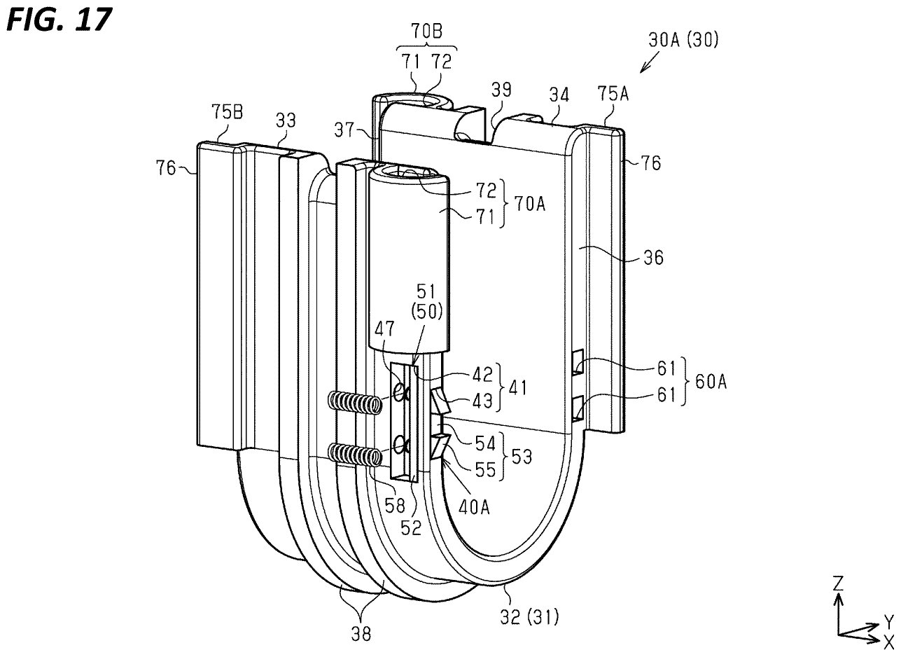

Next, in the step shown in FIG. 16, the latch body 51 is rotated in the accommodation portion 41 along the arrow in the drawing. As a result, the base portion 52 is accommodated in the first recess 42, and the projection base portion 54 of the engagement projection 53 is accommodated in the second recess 43, as shown in FIG. 17.

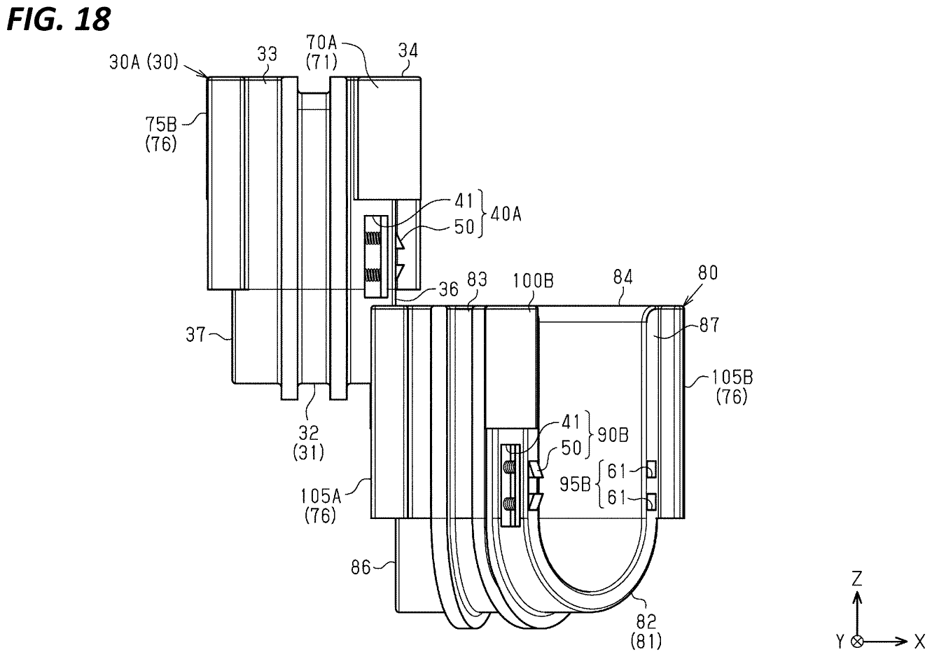

Next, in the step shown in FIG. 17, the biasing member 58 is attached to the latch body 51, and the biasing member 58 is accommodated in the first recess 42 and the third recess 47. As a result, as shown in FIG. 18, a coupling portion 40A having an accommodation portion 41 and a latch portion 50 accommodated in the accommodation portion 41 can be formed. Note that although not shown in the drawings, the other coupling portions 40B, 90A, and 90B can be formed in the same manner.

Next, a method for coupling the straight component 30A and the bent component 80 to each other will be described. Here, the description will focus on the coupling between the coupling portion 40A and the coupling portion 95A, and the engagement between the engagement portion 70A and the engagement portion 105A.

Next, in the step shown in FIG. 18, the straight component 30A is arranged such that the end portion 36 opposes the end portion 86 of the bent component 80. At this time, the straight component 30A is disposed above the bent component 80 with the end surface in the axial direction of the straight component 30A at the end portion 36 brought into contact with the end surface in the axial direction of the bent component 80 at the end portion 86.

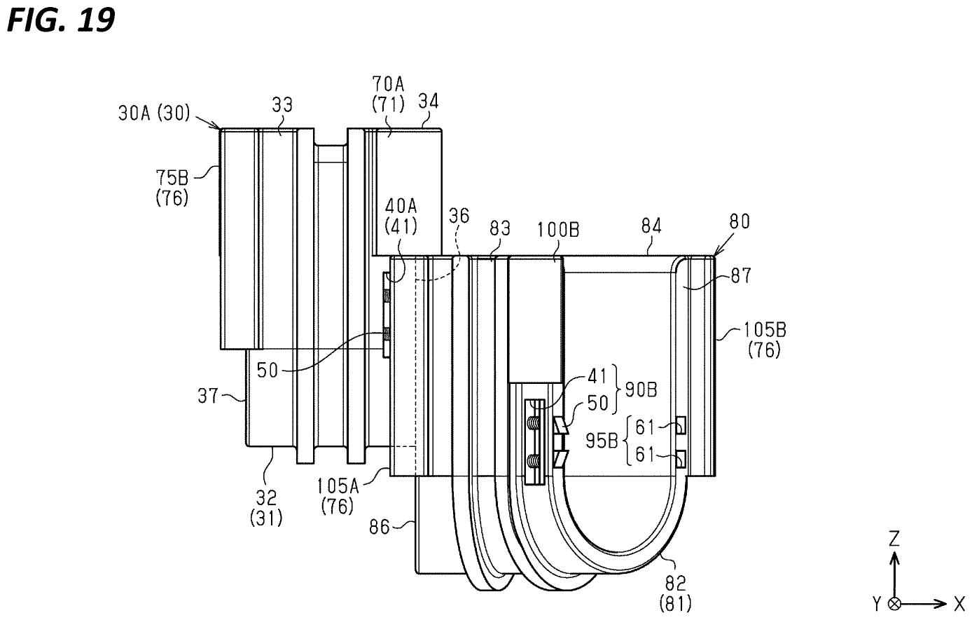

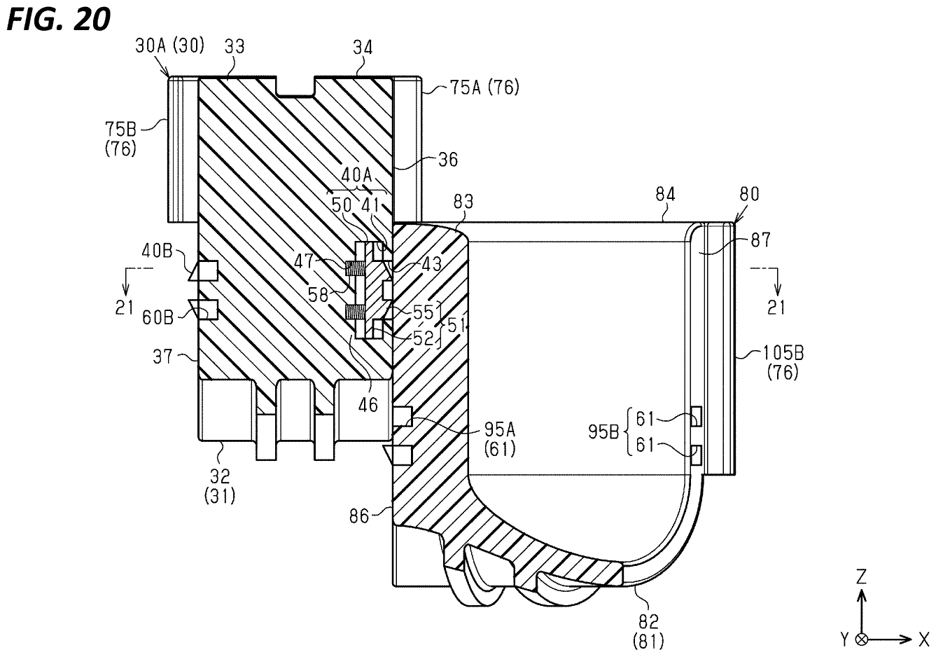

Next, in the step shown in FIG. 19, the straight component 30A is moved downward relative to the bent component 80 while the end surfaces in the axial direction of the end portions 36 and 86 are brought into contact with each other. At this time, the protruding portion 55 of the latch portion 50 of the coupling portion 40A is pressed toward the second peripheral wall 46 of the accommodation portion 41 by the end surface in the axial direction of the bent component 80 at the end portion 86, as shown in FIG. 20. Then, the latch body 51 is displaced to the second orientation in which the protruding portion 55 is accommodated inside the accommodation portion 41 against the biasing force of the biasing member 58. Specifically, the biasing member 58 is compressed between the base portion 52 and the bottom surface of the third recess 47, and the entire latch body 51 is retracted so as to be accommodated in the accommodation portion 41.

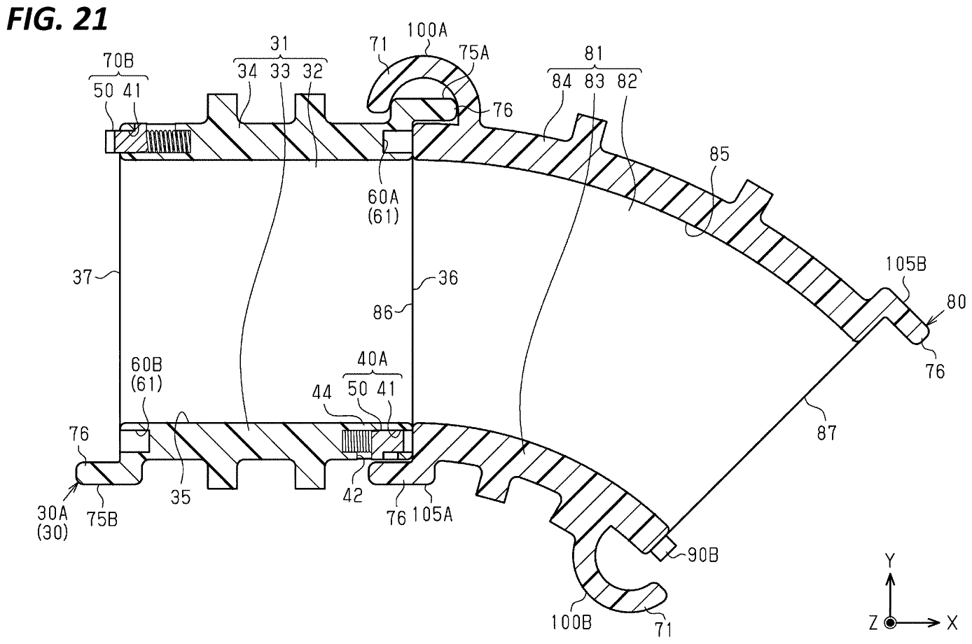

At this time, as shown in FIG. 21, the engagement wall 76 of the engagement portion 105A of the bent component 80 is provided so as to close a portion of the opening of the first recess 42. As a result, the latch portion 50 is sandwiched between the end wall 44 of the accommodation portion 41 and the engagement wall 76 of the engagement portion 105A in the Y-axis direction. For this reason, when the latch portion 50 is displaced to the second orientation, the latch portion 50 can be prevented from coming out of the accommodation portion 41.

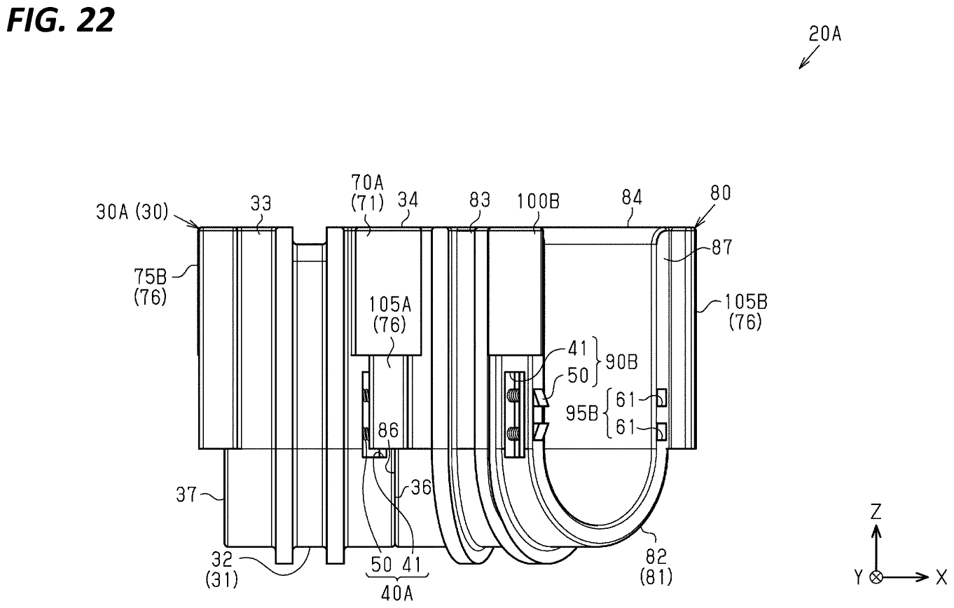

Next, in the step shown in FIG. 22, the straight component 30A is moved further downward while the end surfaces in the axial direction of the end portions 36 and 86 are brought into contact with each other. Then, the engagement wall 76 of the engagement portion 105A of the bent component 80 is inserted into the groove portion 72 (see FIG. 5) of the grip portion 71 of the engagement portion 70A of the straight component 30A along the Z-axis direction. As a result, the outer peripheral surface of the engagement wall 76 and the inner peripheral surface of the grip portion 71 are engaged with each other in the axial direction of the straight component 30A, and the outer peripheral surface of the engagement wall 76 and the inner peripheral surface of the grip portion 71 are engaged with each other in the radial direction of the holding portion 31. For this reason, when the straight component 30A is moved downward, the straight component 30A can be prevented from tilting in the axial direction or the radial direction with respect to the bent component 80. In addition, the straight component 30A is moved downward with the grip portion 71 gripping the engagement wall 76 from the outer side and the latch portion 50 of the coupling portion 40A remaining in the second orientation. Then, as shown in FIG. 9, when the latch portion 50 faces the fitting recess 61 of the coupling portion 95A, the force pressing the protruding portion 55 toward the second peripheral wall 46 is released, and therefore the latch body 51 is biased toward the fitting recess 61 by the biasing force of the biasing member 58. As a result, the protruding portion 55 of the latch portion 50 of the coupling portion 40A is fitted into the fitting recess 61 of the coupling portion 95A. Then, the engagement surface 55A of the protruding portion 55 and the inner surface of the fitting recess 61 are engaged with each other in the peripheral direction of the holding portion 31. Through the above steps, the coupling portion 40A of the straight component 30A and the coupling portion 95A of the bent component 80 can be coupled to each other. Furthermore, as shown in FIG. 22, the engagement portion 70A of the straight component 30A and the engagement portion 105A of the bent component 80 can be engaged with each other. Although not shown in the drawings, the coupling portion 60A of the straight component 30A and the coupling portion 90A of the bent component 80 can be coupled to each other in the same manner, and the engagement portion 75A of the straight component 30A and the engagement portion 100A of the bent component 80 can be engaged with each other in the same manner. This allows the straight component 30A and the bent component 80 to be coupled to each other.

Next, the effects of this embodiment will be described.

(1) The path restriction member 20 includes the straight component 30 having the holding portion 31 that holds the electric wire member 11 and the coupling portion 40A, and the bent component 80 having the holding portion 81 that holds the electric wire member 11 and the coupling portion 95A that is coupled to the coupling portion 40A. The coupling portion 40A has the accommodation portion 41 provided in the holding portion 31 and the latch portion 50 accommodated in the accommodation portion 41. The latch portion 50 has the latch body 51 having the protruding portion 55 that protrudes to the outside of the accommodation portion 41, and the biasing member 58 that biases the latch body 51 toward the coupling portion 95A. The coupling portion 95A has the fitting recess 61 that fits with the protruding portion 55. The latch body 51 is displaceable against the biasing force of the biasing member 58 to an orientation in which the protruding portion 55 is accommodated inside the accommodation portion 41.

According to this configuration, the latch body 51 can be displaced between a first orientation in which the protruding portion 55 protrudes outside the accommodation portion 41 due to the biasing force of the biasing member 58, and a second orientation in which the protruding portion 55 is accommodated inside the accommodation portion 41 against the biasing force of the biasing member 58. In such a latch body 51, when the protruding portion 55 is pressed toward the inside of the accommodation portion 41 by the peripheral walls such as the bottom wall 82 and the side walls 83 and 84 of the bent component 80, the protruding portion 55 is accommodated inside the accommodation portion 41 and displaced to the second orientation. In this second orientation, the protruding portion 55 does not protrude outside the accommodation portion 41, and therefore, the protruding portion 55 is prevented from interfering with the relative movement of the bent component 80 with respect to the straight component 30. In addition, when the protruding portion 55 faces the fitting recess 61 of the coupling portion 95A, the pressure on the protruding portion 55 is released, and the biasing force of the biasing member 58 causes the protruding portion 55 to protrude outside the accommodation portion 41. This allows the protruding portion 55 to be easily fitted into the fitting recess 61, and allows the coupling portion 40A and the coupling portion 95A to be easily coupled to each other. These features improve the workability when coupling the straight component 30 and the bent component 80.

(2) Furthermore, when the coupling portion 40A and the coupling portion 95A are coupled to each other, the protruding portion 55 and the fitting recess 61 are engaged with each other in the peripheral direction of the path restriction member 20. This makes it possible to suppress relative movement of the bent component 80 with respect to the straight component 30 in the peripheral direction of the path restriction member 20.

(3) The biasing member 58 is a coil spring attached to the outer periphery of the columnar projection 57 provided on the second surface 52B of the base portion 52 of the latch body 51. According to this configuration, the coil spring, which is the biasing member 58, can bias the latch body 51 toward the fitting recess 61 of the coupling portion 95A. In addition, when the protruding portion 55 is pressed toward the inside of the accommodation portion 41 by the peripheral walls such as the bottom wall 82 and the side walls 83 and 84 of the bent component 80, the coil spring is compressed, thereby displacing the latch body 51 to the second orientation.

(4) The two protruding portions 55 on the latch portion 50 of the coupling portion 40A are respectively fitted into the two fitting recesses 61 on the coupling portion 95A. As a result, the coupling portion 40A and the coupling portion 95A are coupled to each other. Furthermore, when the coupling portion 40A and the coupling portion 95A are coupled to each other, the engagement surfaces 55A of the two protruding portions 55 and the inner surfaces of the two fitting recesses 61 are engaged with each other in the peripheral direction of the path restriction member 20. Specifically, the two protruding portions 55 are engaged with the inner surface of the fitting recess 61 in both the upward and downward directions in FIG. 9. This makes it possible to suppress relative movement of the bent component 80 with respect to the straight component 30 in the peripheral direction of the path restriction member 20.

(5) The base end portion of the biasing member 58 is accommodated in the third recess 47 provided on the inner surface of the second peripheral wall 46 of the accommodation portion 41. This makes it possible to prevent the biasing member 58 from coming out of the accommodation portion 41, compared to when the base end portion of the biasing member 58 is brought into contact with the inner surface of the second peripheral wall 46. In particular, when the biasing member 58 is compressed as the protruding portion 55 is pressed toward the inside of the accommodation portion 41, the biasing member 58 can be prevented from coming out of the accommodation portion 41. In addition, by accommodating the base end portion of the biasing member 58 in the third recess 47, the position of the biasing member 58 relative to the accommodation portion 41 can be fixed.

(6) The accommodation portion 41 has the first recess 42 recessed from the outer peripheral surface of the holding portion 31, specifically the outer peripheral surface of the side wall 33, toward the inner side in the radial direction of the holding portion 31. The first recess 42 is formed so as not to penetrate through the side wall 33 in the radial direction. For this reason, the end wall 44 is provided to close the opening on the inner side in the radial direction of the first recess 42. The end wall 44 can prevent the latch portion 50 from coming out of the first recess 42.

(7) The straight component 30 has the coupling portion 40A provided on the side wall 33 at the end portion 36 and the engagement portion 70A provided on the side wall 33 at the end portion 36. The bent component 80 has the coupling portion 95A provided on the side wall 83 at the end portion 86 and the engagement portion 105A provided on the side wall 83 at the end portion 86. The engagement portion 70A is engaged with the engagement portion 105A in the axial direction of the path restriction member 20. This makes it possible to suppress relative movement of the bent component 80 with respect to the straight component 30 in the axial direction of the path restriction member 20.

(8) The engagement portion 70A and the engagement portion 105A are engaged with each other in the axial direction of the path restriction member 20 and the radial direction of the holding portion 31. This allows the bending reaction force of the electric wire member 11 to be distributed to the engagement portions 70A and 105A when the electric wire member 11 is accommodated in the path restriction member 20. As a result, the bending reaction force of the electric wire member 11 can be prevented from being concentrated at the latch portion 50, and therefore damage to the latch portion 50 can be suppressed.

(9) The engagement wall 76 of the engagement portion 105A covers a portion of the latch portion 50 from the outer side in the radial direction of the holding portion 31. The engagement wall 76 can prevent the latch portion 50 from coming out of the accommodation portion 41.

(10) The grip portion 71 of the engagement portion 70A and the engagement wall 76 of the engagement portion 105A are engaged with each other in the radial direction of the holding portion 31. This makes it possible to suppress relative movement of the bent component 80 with respect to the straight component 30 in the radial direction of the holding portion 31.

(11) At the end portion 36 of the straight component 30, the side wall 33 is provided with the coupling portion 40A, and the side wall 34 is provided with the coupling portion 60A having the same structure as the coupling portion 95A. On the other hand, at the end portion 37 of the straight component 30, the coupling portion 40B having the same structure as the coupling portion 40A is provided on the side wall 34, and the coupling portion 60B having the same structure as the coupling portion 95A is provided on the side wall 33. In this way, the coupling portions 40B and 60B at the end portion 37 of the straight component 30 are formed in a structure that is a 180-degree rotation of the structure of the coupling portions 40A and 60A at the end portion 36 of the straight component 30. For this reason, the bent component 80 can be coupled to the end portion 36 of the straight component 30 and to the end portion 37 of the straight component 30 as well. This allows the direction in which the bent component 80 is coupled to the straight component 30 to be changed appropriately in accordance with the path of the electric wire member 11.

### Other Embodiments

The above-described embodiment can be modified as follows. The above-described embodiment and the following modified examples can be implemented in combination with each other to the extent that no technical contradiction occurs.
The structures of the coupling portions 40A, 40B, 90A, and 90B in the above-described embodiment can be modified as appropriate. In the following description, the coupling portion 40A will be focused on, but the coupling portions 40B, 90A, and 90B can also be modified in the same manner.
The third recess 47 in the accommodation portion 41 of the coupling portion 40A may be omitted.
The first recess 42 in the accommodation portion 41 of the coupling portion 40A may be formed to penetrate through the side wall 33 in the thickness direction. That is, the first recess 42 may be formed so as to open toward the inner side in the radial direction of the holding portion 31.
The structure of the latch portion 50 of the coupling portion 40A can be modified as needed. For example, the number of the protruding portions 55 of the latch portion 50 may be changed to one. For example, the flange portion 57A of the columnar projection 57 may be omitted. For example, the biasing member 58 may be changed to a biasing member other than a coil spring.
The structures of the coupling portions 60A, 60B, 95A, and 95B according to the above-described embodiments can be modified as appropriate. For example, the coupling portions 60A, 60B, 95A, and 95B may be constituted by one fitting recess 61.
The structures of the engagement portions 70A, 70B, 100A, and 100B according to the above-described embodiment can be modified as appropriate. For example, the length of the grip portion 71 may be changed as appropriate.
The structures of the engagement portions 75A, 75B, 105A, and 105B according to the above-described embodiment can be modified as appropriate. For example, the length of the engagement wall 76 may be changed as appropriate.
The structure of the holding portion 31 of the straight component 30 in the above-described embodiment can be modified as appropriate. For example, the reinforcing rib 38 may be omitted. For example, the groove portion 39 may be omitted.
The structure of the holding portion 81 of the bent component 80 in the above-described embodiment can be modified as appropriate. For example, the reinforcing rib 88 may be omitted.
The latch portion 50 in the coupling portion 40B of the straight component 30A according to the above-described embodiment may be omitted. Similarly, the latch portion 50 at the coupling portion 40A of the straight component 30B may be omitted.
The structure of the path restriction member 20 according to the above-described embodiment can be modified as appropriate. For example, by changing the combination of the straight components 30 and the bent components 80, that is, by changing the numbers and coupling directions of the straight components 30 and the bent components 80, the path restriction member 20 can be formed into various structures. The numbers of the straight components 30 and the bent components 80 that constitute the path restriction member 20 are not particularly limited. For example, the path restriction member 20 may be constituted by only two or more straight components 30. For example, the path restriction member 20 may be constituted by only two or more bent components 80.

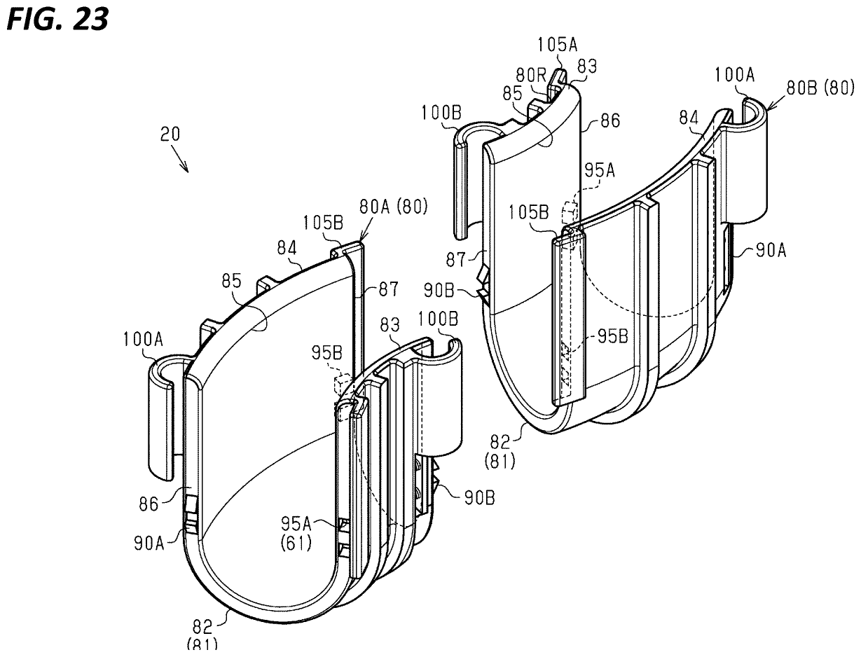

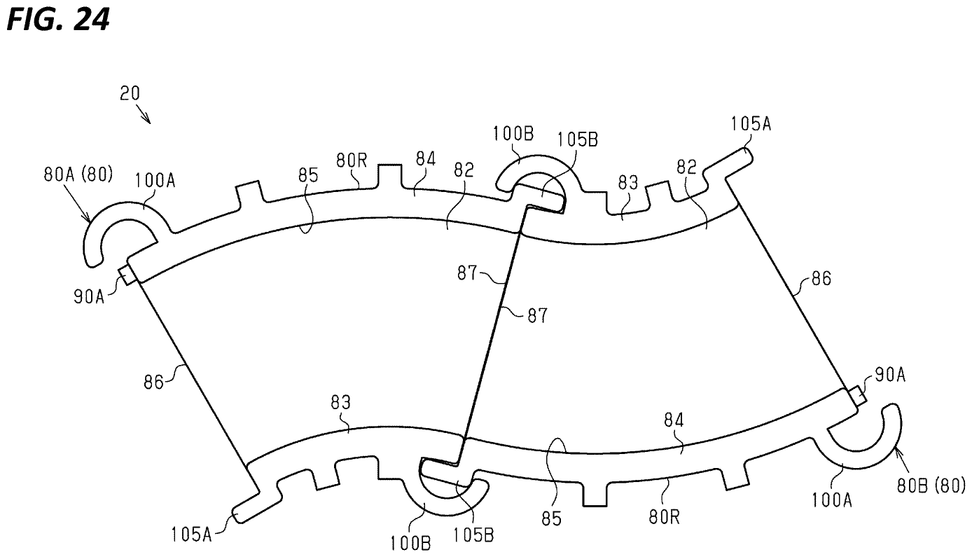

For example, as shown in FIGS. 23 and 24, the path restriction member 20 may be formed by coupling two bent components 80A and 80B. Here, each of the bent components 80A and 80B has the same structure as the bent component 80 shown in FIG. 5 and the like. The bent component 80B is arranged in a state where the structure of the bent component 80A is rotated by 180 degrees, for example. As shown in FIG. 23, the bent component 80A and the bent component 80B are coupled to each other with the end portion 87 of the bent component 80A and the end portion 87 of the bent component 80B opposing each other. For example, the coupling portion 95B provided at the end portion 87 of the side wall 84 of the bent component 80B is coupled to the coupling portion 90B provided at the end portion 87 of the side wall 83 of the bent component 80A. In addition, the coupling portion 95B provided at the end portion 87 of the side wall 84 of the bent component 80A is coupled to the coupling portion 90B provided at the end portion 87 of the side wall 83 of the bent component 80B.

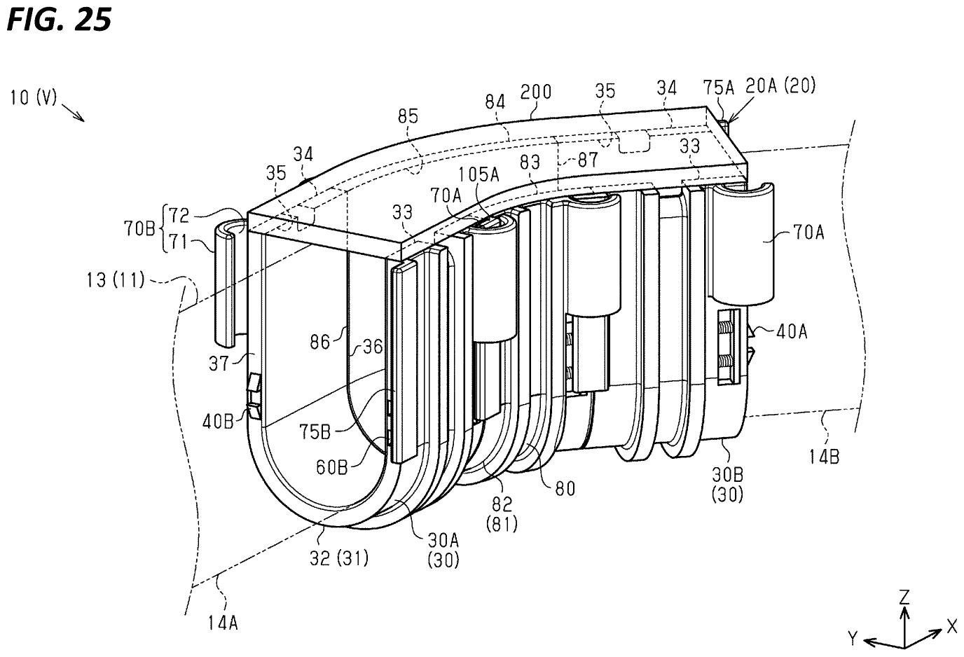

As shown in FIG. 24, the path restriction member 20 of this modified example is formed in a shape in which a right bent portion and a left bent portion are continuous with each other along the axial direction of the path restriction member 20 in a plan view as viewed from the Z-axis direction.
In the above-described embodiment, the path restriction members 20 are provided at only the bent portions 15A, 15B, 15C, 15D, and 15E of the routing path of the electric wire member 11, but there is no limitation to this. For example, the path restriction members 20 may be provided for the straight portions 14A, 14B, 14C, 14D, 14E, and 14F as well. For example, the path restriction member 20 may be provided at the straight portion 14C provided between the path restriction member 20B and the path restriction member 20C. For example, the straight component 30 that is coupled to both of the path restriction members 20C and 20D may be provided for the straight portion 14D that is provided between the path restriction members 20C and 20D. In this case, the path restriction member 20C and the path restriction member 20D are formed integrally by the straight component 30 provided at the straight portion 14D. In this case, the planar shape of the path restriction members 20C and 20D is formed in an S-shape.
For example, as shown in FIG. 25, the path restriction member 20 may also include a lid portion 200 that closes the insertion openings 35 of the straight components 30A and 30B and the insertion opening 85 of the bent component 80. The lid portion 200 is provided so as to entirely cover the insertion openings 35 of the straight components 30A and 30B and entirely cover the insertion opening 85 of the bent component 80, for example. The lid portion 200 is provided on the upper surfaces of the side walls 33 and 34 of the straight components 30A and 30B, and is provided on the upper surfaces of the side walls 83 and 84 of the bent component 80, for example. The lid portion 200 is coupled to the straight components 30A and 30B and the bent component 80 by, for example, coupling members (not shown). Note that the lid portion 200 may also be formed by a body panel of a vehicle V.
The size of the bending angle θ in the bent portions 80R of the bent component 80 in the above-described embodiments can be modified as appropriate.
The electric wire member 11 of the above-described embodiments does not necessarily need to include the exterior member 13. That is, the holding portions 31 and 81 may directly hold the electric wires 12.
The electric wire member 11 of the above-described embodiments may also include a tubular electromagnetic shield member that surrounds the outer periphery of the electric wires 12.
The arrangement relationship between the inverter M1 and the high-voltage battery M2 in the vehicle V is not limited to those in the above-described embodiments, and may be modified as appropriate depending on the vehicle configuration.
The plurality of electric devices to which the wire harness 10 of the above-described embodiments are electrically connected are not limited to the inverter M1 and the high-voltage battery M2, and are not particularly limited as long as they are electrical devices mounted in the vehicle V.
In the non-limiting example shown in the drawings, the engagement wall 76 of the engagement portion 105A of the bent component 80 may be inserted into the groove portion 72 of the engagement portion 70A of the straight component 30A along the height direction of the side wall 33. After the coupling, the engagement wall 76 of the engagement portion 105A of the bent component 80 and the engagement portion 70A of the straight component 30A may be incapable of pivoting relative to each other. After the coupling, the grip portion 71 of the engagement portion 70A may press the outer peripheral surface of the engagement portion 105A using the elastic returning force of the grip portion 71. The same applies also to the engagement portion 75A of the straight component 30A and the engagement portion 100A of the bent component 80. The coupling between the engagement portion 105A and coupling portion 95A of the bent component 80 and the engagement portion 70A and coupling portion 40A of the straight component 30A may be performed at the same time as the coupling between the engagement portion 75A and coupling portion 60A of the straight component 30A and the engagement portion 100A and coupling portion 90A of the bent component 80.
As in the non-limiting example shown in FIG. 5, each grip portion 71 of the engagement portions 70A and 70B of the straight component 30A may define a groove portion 72 having a groove length along the height direction (Z-axis) of the straight component 30A. Each grip portion 71 of the engagement portions 100A and 100B of the bent component 80 may define a groove portion 72 having a groove length along the height direction (Z-axis) of the bent component 80. Each of the engagement walls 76 of the engagement portions 75A and 75B of the straight component 30A may have an engagement wall length along the height direction (Z-axis) of the straight component 30A. Each of the engagement walls 76 of the engagement portions 105A, 105B of the bent component 80 may have an engagement wall length along the height direction (Z-axis) of the bent component 80.

According to this configuration, as in the non-limiting example shown in FIGS. 18 and 19, the worker first positions the engagement wall 76 of one of the engagement portions 105A and 105B of one bent component 80 with the groove end, that is, the opening end of the groove portion 72 of the grip portion 71 of one of the engagement portions 70A and 70B of one straight component 30A, and then positions the engagement wall 76 of one of the engagement portions 75A and 75B of the straight component 30A with the groove end, that is, the opening end of the groove portion 72 of the grip portion 71 of one of the engagement portions 100A and 100B of the bent component 80. Next, the worker can insert the plurality of engagement walls 76 into the corresponding plurality of groove portions 72, respectively, and slide them along the groove portions 72 in the height direction of the bent component 80 and the straight component 30A, thereby coupling the straight component 30A and the bent component 80 in a row in the length direction. In this way, when coupling one straight component 30A and one bent component 80 to each other in a row in the longitudinal direction, this coupling work can be performed by sliding one end portion in the longitudinal direction of the bent component 80 and one end portion in the longitudinal direction of the straight component 30A along the height direction of the bent component 80 and the straight component 30A, without substantially moving the straight component 30A and the bent component 80 relative to each other in the longitudinal direction. The same applies also to the work of coupling a plurality of straight components 30A and 30B and the work of coupling a plurality of bent components 80.
The embodiments disclosed herein are to be considered as illustrative in all respects and not restrictive. The scope of the present invention is defined not by the above meaning, but by the claims, and is intended to encompass all modifications within the meaning and scope equivalent to the claims.

### LIST OF REFERENCE NUMERALS

10 Wire harness
11 Electric wire member
12 Electric wire
13 Exterior member
14A, 14B, 14C, 14D, 14E, 14F Straight portion
15A, 15B, 15C, 15D, 15E Bent portion
20, 20A, 20B, 20C, 20D, 20E Path restriction member
30, 30A, 30B Straight component (first restriction component)
31 Holding portion (first holding portion)
32 Bottom wall (first bottom wall)
33 Side wall (first side wall)
34 Side wall (second side wall)
35 Insertion opening
36 End portion (first end portion)
37 End portion (second end portion)
38 Reinforcing rib
39 Groove portion
40A Coupling portion (first coupling portion)
40B Coupling portion (fourth coupling portion)
41 Accommodation portion
42 First recess
43 Second recess
44 End wall
45 First peripheral wall
46 Second peripheral wall
47 Third recess
50 Latch portion
51 Latch body
52 Base portion
52A First surface
52B Second surface
53 Engagement projection
54 Engagement base portion
55 Protruding portion
55A Engagement surface
55B Distal end surface
57 Columnar projection
57A Flange portion
58 Biasing member (coil spring)
60A Coupling portion (third coupling portion)
60B Coupling portion (fifth coupling portion)
61 Fitting recess
70A Engagement portion (first engagement portion)
70B Engagement portion
71 Grip portion
72 Groove portion
75A, 75B Engagement portion
76 Engagement wall
80 Bent component (second restriction component)
80A Bent component (first bent component)
80B Bent component (second bent component)
80R Bent portion
81 Holding portion (second holding portion)
82 Bottom wall (second bottom wall)
83 Side wall (third side wall)
84 Side wall (fourth side wall)
85 Insertion opening
86 End portion (third end portion)
87 End portion (fourth end portion)
88 Reinforcing rib
90A Coupling portion (sixth coupling portion)
90B Coupling portion
95A Coupling portion (second coupling portion)
95B Coupling portion
100A Engagement portion
100B Engagement portion
105A Engagement portion (second engagement portion)
105B Engagement portion
120 Slide restricting member
200 Lid portion
θ, θ1, θ2, θ3, θ4, θ5 Bending angle
M1 Inverter
M2 High-voltage battery
V Vehicle

1. A path restriction member for restricting a path of an electric wire member, comprising:
a first restriction component; and
a second restriction component coupled to the first restriction component,
wherein the first restriction component has a first holding portion configured to hold the electric wire member, and a first coupling portion,
the second restriction component has a second holding portion configured to hold the electric wire member, and a second coupling portion that is coupled to the first coupling portion,
the first coupling portion has an accommodation portion provided in the first holding portion and a latch portion accommodated in the accommodation portion,
the latch portion includes a latch body having a protruding portion protruding outside the accommodation portion, and a biasing member that biases the latch body toward the second coupling portion,
the second coupling portion has a fitting recess configured to fit together with the protruding portion, and
the latch body is displaceable against the biasing force of the biasing member to an orientation in which the protruding portion is accommodated inside the accommodation portion.

2. The path restriction member according to claim 1,
wherein the latch body has a base portion including a first surface and a second surface provided on a side opposite to the first surface, an engagement projection protruding from the first surface toward the fitting recess, and a columnar projection protruding from the second surface,
the engagement projection includes a projection base portion provided on the first surface and the protruding portion provided at a distal end of the projection base portion, and
the biasing member is a coil spring attached to an outer periphery of the columnar projection.

3. The path restriction member according to claim 2,
wherein the engagement projection includes two of the protruding portions that are provided at the distal end of the projection base portion and are spaced apart from each other in a peripheral direction of the path restriction member,
the second coupling portion includes two of the fitting recesses into which the two protruding portions are to be respectively fitted, and
each of the two protruding portions has an engagement surface configured to engage with an inner surface of the fitting recess in the peripheral direction of the path restriction member.

4. The path restriction member according to claim 3,
wherein each of the two protruding portions has a distal end surface facing the fitting recess,
the two engagement surfaces oppose each other in the peripheral direction of the path restriction member, and
the distal end surface is inclined such that a protrusion amount of the protruding portion from the projection base portion decreases as the distance from the other protruding portion increases in the peripheral direction of the path restriction member.

5. The path restriction member according to claim 1,
wherein the accommodation portion has a first recess recessed from an outer peripheral surface of the first holding portion toward an inner side in a radial direction of the first holding portion, a second recess that is recessed from an end surface in an axial direction of the first holding portion and is in communication with the first recess, a first peripheral wall that constitutes the inner surface of the first recess and in which the second recess is formed, a second peripheral wall that constitutes the inner surface of the first recess and opposes the first peripheral wall, and a third recess provided in the inner surface of the second peripheral wall, and
an end portion of the biasing member is accommodated in the third recess.

6. The path restriction member according to claim 5,
wherein the first recess is formed so as not to penetrate through the first holding portion in the radial direction.

7. The path restriction member according to claim 1,
wherein the first holding portion has a first bottom wall, a first side wall protruding from a first side edge of the first bottom wall, and a second side wall protruding from a second side edge of the first bottom wall,
the first restriction component has a first end portion in an axial direction of the first restriction component and a second end portion provided on a side opposite to the first end portion,
the first restriction component has the first coupling portion provided on the first side wall at the first end portion and a first engagement portion provided on the first side wall at the first end portion,
the second holding portion has a second bottom wall, a third side wall protruding from a third side edge of the second bottom wall, and a fourth side wall protruding from a fourth side edge of the second bottom wall,
the second restriction component has a third end portion in the axial direction of the second restriction component and a fourth end portion provided on a side opposite to the third end portion,
the second restriction component has the second coupling portion provided on the third side wall at the third end portion and a second engagement portion provided on the third side wall at the third end portion, and
the first engagement portion is engaged with the second engagement portion in the axial direction of the path restriction member.

8. The path restriction member according to claim 7,
wherein the second engagement portion has an engagement wall that extends from an outer peripheral surface at a distal end of the third side wall toward the second bottom wall and protrudes outward of the second holding portion from the outer peripheral surface of the third side wall toward the axial direction of the second holding portion,
the engagement wall is engaged with an outer peripheral surface of the first side wall in a radial direction of the first holding portion, and
the engagement wall covers a portion of the latch portion from an outer side in the radial direction of the first holding portion.

9. The path restriction member according to claim 8,
wherein the first engagement portion has a grip portion configured to grip the engagement wall, and
the grip portion is engaged with the engagement wall in the axial direction of the path restriction member and is engaged with the engagement wall in the radial direction of the first holding portion.

10. The path restriction member according to claim 7,
wherein the first restriction component has a third coupling portion provided on the second side wall at the first end portion, a fourth coupling portion provided on the second side wall at the second end portion, and a fifth coupling portion provided on the first side wall at the second end portion,
the second restriction component has a sixth coupling portion provided on the fourth side wall at the third end portion,
the third coupling portion has the same structure as the second coupling portion,
the fourth coupling portion has the same structure as the first coupling portion,
the fifth coupling portion has the same structure as the second coupling portion, and
the sixth coupling portion has the same structure as the first coupling portion.

11. The path restriction member according to claim 1,
wherein the first restriction component is a straight component formed such that the first holding portion extends linearly in one direction, and
the second restriction component is a bent component in which the second holding portion has a bent portion.

12. The path restriction member according to claim 1,
wherein the first restriction component is a first bent component in which the first holding portion has a bent portion, and
the second restriction component is a second bent component having the same structure as the first bent component.

13. A wire harness, comprising:
the path restriction member according to claim 1; and
the electric wire member whose path is restricted by the path restriction member.
